(19) United States
(12) Patent Application Publication
(10) Pub. No.: US 2026/0052561 A1
(43) Pub. Date: Feb. 19, 2026

(54) SLOT PRIORITIZATION FOR CONNECTED MODE DISCONTINUOUS RECEPTION

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 18/808,764

(22) Filed: Aug. 19, 2024

(51) Int. Cl. H04W 72/563; H04L 1/1812; H04W 72/0446; H04W 76/28

(52) U.S. Cl. CPC H04W 72/563; H04L 1/1812; H04W 72/0446; H04W 76/28

(57) ABSTRACT

Various aspects of the present disclosure generally relate to wireless communication. Some aspects more specifically relate to defining a first set of one or more slots of a discontinuous reception (DRX) on duration (or active time) with a first priority level. A user equipment (UE) may monitor a physical downlink control channel (PDCCH) in the first set of one or more slots. A second set of one or more slots of the DRX on duration may have a second priority level. The UE may monitor the PDCCH in the second set of one or more slots only if a PDCCH is received in the first set of one or more slots. In some aspects, a network node may adjust a connected-mode DRX related timer based on an indication via radio resource control signaling, medium access control signaling, or downlink control information.

### FIELD OF THE DISCLOSURE

Aspects of the present disclosure generally relate to wireless communication and specifically relate to techniques, apparatuses, and methods associated with slot prioritization for connected mode discontinuous reception.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

Discontinuous reception (DRX) provides a way for a wireless communication device, such as a user equipment (UE) or a network node, to save power. DRX involves periodic on durations in which the wireless communication device performs communications, and periodic off durations in which the wireless communication device enters a sleep mode. DRX can be implemented at a UE (such as in the form of connected mode DRX (C-DRX) or idle/inactive mode DRX (I-DRX)) or at a network (such as in the form of cell DRX). Similarly, a network node may implement discontinuous transmission (DTX) (such as cell DTX), in which transmission operations of the network node are deactivated during some time intervals. While DRX and DTX save power, some amount of power is still consumed during active times, and active times may not always be fully utilized (particularly for certain forms of communications such as small data transfers).

### SUMMARY

In some aspects, a method of wireless communication at a user equipment (UE) may include receiving an indication of a slot pattern comprising a first set of one or more slots having a first priority level and a second set of one or more slots having a second priority level, wherein the first set of one or more slots and the second set of one or more slots are included in an active time of a discontinuous reception (DRX) cycle. The method may include monitoring for a second grant in the second set of one or more slots in accordance with the slot pattern, or refraining from monitoring for the second grant in the second set of one or more slots, in association with whether a first grant is detected in the first set of one or more slots.

In some aspects, a method of wireless communication at a network node may include transmitting, to a UE, a DRX configuration indicating a DRX cycle. The method may include transmitting an indication a slot pattern comprising of a first set of one or more slots having a first priority level and a second set of one or more slots having a second priority level, wherein the first set of one or more slots and the second set of one or more slots are included in an active time of the DRX cycle.

In some aspects, a UE may include a processing system that includes processor circuitry and memory circuitry that stores code. The processing system may be configured to cause the UE to receive an indication of a slot pattern comprising a first set of one or more slots having a first priority level and a second set of one or more slots having a second priority level, wherein the first set of one or more slots and the second set of one or more slots are included in an active time of a DRX cycle. The processing system may be configured to cause the UE to monitor for a second grant in the second set of one or more slots in accordance with the slot pattern, or refrain from monitoring for the second grant in the second set of one or more slots, in association with whether a first grant is detected in the first set of one or more slots.

In some aspects, a network node may include a processing system that includes processor circuitry and memory circuitry that stores code. The processing system may be configured to cause the network node to transmit, to a UE, a DRX configuration indicating a DRX cycle. The processing system may be configured to cause the network node to transmit an indication of a slot pattern comprising a first set of one or more slots having a first priority level and a second set of one or more slots having a second priority level, wherein the first set of one or more slots and the second set of one or more slots are included in an active time of the DRX cycle.

In some aspects, a non-transitory computer-readable medium may store one or more instructions for wireless communication. The one or more instructions, when executed by one or more processors of a UE, may cause the one or more processors to receive an indication of a slot pattern comprising a first set of one or more slots having a first priority level and a second set of one or more slots having a second priority level, wherein the first set of one or more slots and the second set of one or more slots are included in an active time of a DRX cycle. The one or more instructions, when executed by one or more processors of a UE, may cause the one or more processors to monitor for a second grant in the second set of one or more slots in accordance with the slot pattern, or refrain from monitoring for the second grant in the second set of one or more slots, in association with whether a first grant is detected in the first set of one or more slots.

In some aspects, an apparatus may include means for receiving an indication of a slot pattern comprising a first set of one or more slots having a first priority level and a second set of one or more slots having a second priority level, wherein the first set of one or more slots and the second set of one or more slots are included in an active time of a DRX cycle. The apparatus may include means for monitoring for a second grant in the second set of one or more slots in accordance with the slot pattern, or refraining from monitoring for the second grant in the second set of one or more slots, in association with whether a first grant is detected in the first set of one or more slots.

In some aspects, an apparatus may include means for transmitting, to a UE, a DRX configuration indicating a DRX cycle. The apparatus may include means for transmitting an indication a slot pattern comprising of a first set of one or more slots having a first priority level and a second set of one or more slots having a second priority level, wherein the first set of one or more slots and the second set of one or more slots are included in an active time of the DRX cycle.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated base station architecture.

FIG. 3 is a diagram illustrating an example of a discontinuous reception (DRX) configuration.

FIG. 4 is a diagram illustrating an example of a downlink hybrid automatic repeat request (HARQ) round-trip time (RTT) timer and a downlink HARQ retransmission timer.

FIG. 5 is a diagram illustrating an example of an uplink HARQ RTT timer and an uplink HARQ retransmission timer.

FIG. 6 is a diagram illustrating an example of cell discontinuous transmission (DTX) and DRX.

FIG. 7 is a diagram illustrating an example of a slot pattern for a DRX active time.

FIG. 8 is a diagram illustrating an example of signaling associated with configuring a slot pattern for a DRX active time.

FIG. 9 is a diagram illustrating an example process performed, for example, by a UE.

FIG. 10 is a diagram illustrating an example process performed, for example, by a network node.

FIG. 11 is a diagram of an example apparatus for wireless communication.

FIG. 12 is a diagram of an example apparatus for wireless communication.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A wireless communication network may implement various power saving techniques. Two example power saving techniques are discontinuous reception (DRX) and discontinuous transmission (DTX). DRX provides a way for a wireless communication device, such as a user equipment (UE) or a network node, to save power during a periodic off duration (also referred to as an inactive time or non-active time) in which the wireless communication device does not perform some forms of communication. During a periodic on duration, the wireless communication device performs communications (such as by monitoring a physical downlink control channel (PDCCH) or an uplink transmission). DTX may provide for transmission operations of the network node to be deactivated during some time intervals. At the network node, DTX may be referred to as “cell DTX” and DRX may be referred to as “cell DRX.” Thus, the network node may cease or restrict transmission and/or reception in certain time intervals in accordance with cell DTX and/or cell DTX (collectively referred to herein as “cell DTX/DRX”). Cell DTX/DRX may allow the network node to enter a low power state such as a sleep state in a time interval, so long as communications to and from the network node can successfully be avoided in the time interval. Thus, cell DTX/DRX may be referred to as a network energy saving technique.

A UE may implement a connected-mode DRX (C-DRX) cycle while the UE is connected to a network. In a C-DRX cycle, the UE may periodically enter an on duration and monitor a PDCCH. If the UE detects a PDCCH in the on duration, the UE may extend the on duration in accordance with a DRX inactivity timer, and may continue to monitor for further PDCCHs or perform other communications while in an active state. After the DRX inactivity timer has expired (or if the UE does not detect any PDCCH in the DRX on duration), the UE may enter a sleep state during an off duration. In the sleep state, some circuitry of the UE, such as radio frequency circuitry or a receive chain, may be powered down or in a low power state. Upon reaching a next DRX on duration, the UE may power up the circuitry and monitor for a PDCCH.

A C-DRX cycle may be configured using various parameters. For example, the DRX inactivity timer defined above may indicate how long a DRX on duration is extended when a PDCCH is received in the DRX on duration. As another example, a slot offset may indicate a slot in which a DRX on duration of the C-DRX cycle is to start. As another example, a DRX cycle length may indicate a length of time from the start of a first DRX on duration to a start of a next DRX on duration. As another example, a hybrid automatic repeat request (HARQ) round-trip time (RTT) timer and a HARQ retransmission timer may indicate time intervals associated with retransmission of a communication. For example, a downlink HARQ RTT timer may indicate a minimum length of time before a downlink HARQ retransmission is expected by the UE, and a HARQ retransmission timer may indicate a length of a time interval in which the UE monitors for a PDCCH relating to the downlink HARQ retransmission. An uplink HARQ RTT timer may indicate a minimum length of time before an uplink HARQ retransmission grant or other request is expected at the UE. These parameters may generally be configured via semi-static signaling, such as radio resource control (RRC) signaling.

While a C-DRX cycle saves power, the UE still consumes some amount of power throughout a DRX on duration in connection with monitoring the PDCCH. Furthermore, in many deployments such as commercial deployments, communications between UEs and network nodes involve relatively small transmissions, which may not involve repeated PDCCH scheduling or communication within a DRX on duration. In such deployments, a UE continuously monitoring for PDCCHs throughout a DRX on duration may consume power with limited benefit. Furthermore, cell DTX/DRX may provide a desirable level of energy savings only if the network node can successfully enter a sleep state during a non-active time. However, different UEs may use different DRX configurations and may trigger DRX inactivity timers at different times, leading to these UEs being active at different times (and leading to a significant proportion of the network node's time being occupied by DRX on durations for various UEs). Thus, efforts of the network node to enter a sleep state may be impeded, reducing the effectiveness of cell DTX/DRX and increasing network node and UE power consumption. Similarly, the different DRX configurations may lead to a number of resources being set aside for PDCCHs. Such resources may not be used for other communications unless explicitly released (using a “dummy downlink control information” carrying no grant to indicate a PDCCH skip), thus reducing scheduling efficiency and/or increasing overhead.

Furthermore, as mentioned, many C-DRX configuration parameters are configured via semi-static signaling, such as RRC signaling. However, using semi-static signaling to configure C-DRX configuration parameters may be inefficient for scenarios where the DRX configuration needs to be changed frequently, such as in high-mobility environments. Furthermore, as examples, a DRX inactivity timer that is too long may increase UE power consumption while monitoring PDCCHs, while a DRX inactivity timer that is too short may increase latency. If the DRX configuration is to be updated rapidly using semi-static signaling in such situations, overhead and latency may be incurred, and resources may be used inefficiently.

Various aspects relate generally to configuration and operation of C-DRX cycles at a UE and/or cell DTX/DRX at a network node. Some aspects more specifically relate to defining a first part of a DRX on duration (or active time) in which a UE may monitor a PDCCH, and a second part of a DRX on duration in which the UE may monitor the PDCCH or perform another communication only if a PDCCH is received in the first part of the DRX on duration. In some aspects, the first part of the DRX on duration may be positioned earlier in the on duration than the second part of the on duration (that is, the first part may be “frontloaded”). In some aspects, a network node may align the DRX on durations (or first parts of the DRX on durations) across multiple UEs, and may transmit PDCCHs for the multiple UEs in the DRX on durations (or the first parts of the DRX on durations) in a multiplexed fashion. In some examples, the network node may enter a sleep duration in the second part of the DRX on duration (such as in accordance with a cell DTX/DRX configuration).

Some aspects relate to adjusting DRX parameters at a UE using dynamic signaling. For example, the UE may receive an adjustment to a timer parameter of a DRX configuration via dynamic signaling (such as downlink control information (DCI) or a medium access control control element (MAC-CE)). In some aspects, the UE may transmit capability information that indicates support for the adjustment. In some aspects, the adjustment may be an incremental adjustment. For example, the adjustment may be an incremental change to a length of a timer. In some aspects, the adjustment may indicate to reset the timer (for example, to reset an inactivity timer to a zero value).

Particular aspects of the subject matter described in this disclosure can be implemented to realize one or more of the following potential advantages. In some examples, by defining a first part of a DRX on duration (or active time) in which a UE may monitor a PDCCH, and a second part of the DRX on duration in which the UE may monitor the PDCCH or perform another communication only if a PDCCH is received in the first part, the described techniques can be used to reduce UE power consumption in connection with a C-DRX cycle. Furthermore, by positioning the first part of the DRX on duration earlier than the second part, the UE can determine whether to monitor the second part of the DRX on duration prior to the second part occurring, which saves UE resources that would otherwise be used to buffer information of the second part during the DRX on duration. Still further, by aligning the first parts of DRX on durations across the multiple UEs, and transmitting PDCCHs for the multiple UEs in the DRX on durations (or first parts of the on durations) in a multiplexed or multiple-input multiple-output fashion, the network node may reduce the amount of resources that are set aside for PDCCHs, thereby reducing network congestion and avoiding overhead associated with explicit signaling to release PDCCH resources. Furthermore, in this situation, the network node may enter a sleep state, thereby conserving energy at the network node.

Particular aspects of the subject matter described in this disclosure can be implemented to realize one or more of the following potential advantages. In some examples, by providing an adjustment to a timer parameter of a DRX configuration via dynamic signaling, latency associated with reconfiguration of the DRX configuration is reduced, and responsiveness to changing conditions is improved. For example, in a situation where an inactivity timer is lengthened, latency may be reduced. As another example, in a situation where an inactivity timer is shortened, power consumption may be reduced. By providing capability information that indicates support for the adjustment, usage of the dynamic adjustment of timer parameters can be specific to the capabilities of each UE, thereby reducing the occurrence of misconfiguration of dynamic adjustment of timer parameters. By providing an incremental adjustment a length of a timer, aspects described herein enable granular adjustment of timer parameters, further improving efficiency, reducing power consumption, and/or reducing latency. In some aspects, by providing an indication to reset the timer, aspects described herein may enable extension of the timer in certain situations, such as when there is additional data to transmit to the UE.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

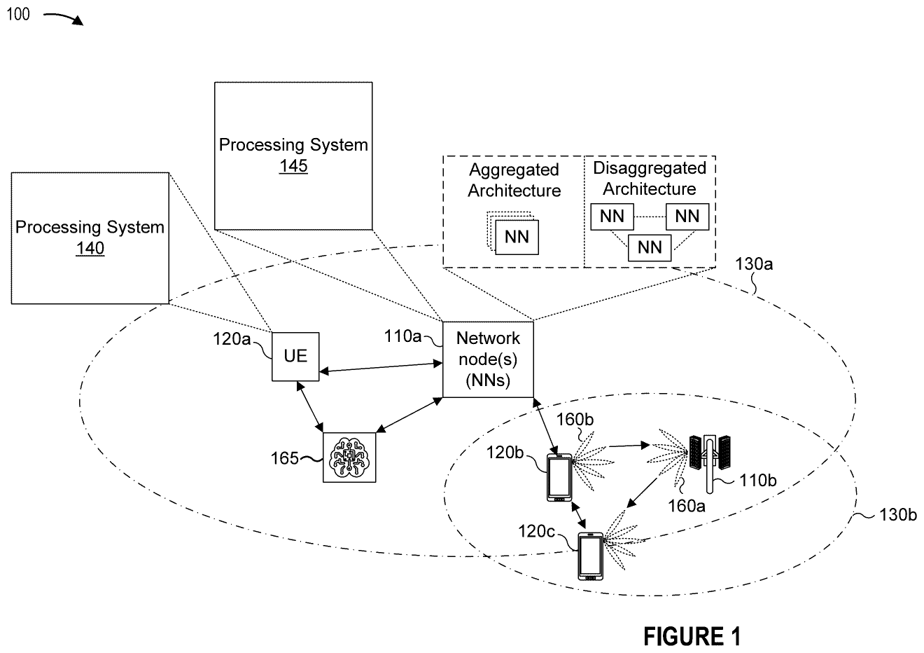

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

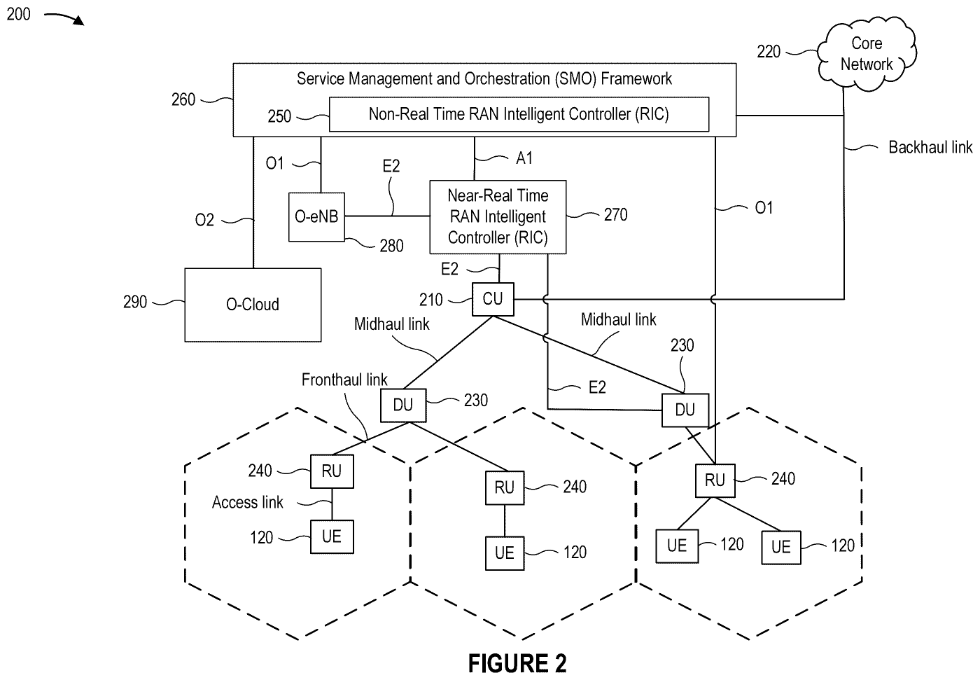

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as an FFT, an IFFT, beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify resource blocks (RBs) in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

An uplink signal may include a reference signal, control information or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement indication or a HARQ negative acknowledgement indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a cyclic prefix (CP)-OFDM (CP-OFDM) waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an inverse fast Fourier transform (IFFT) operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, a fast Fourier transform (FFT) operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160b of the network node 110) and the UE 120 receiving and measuring the signal(s) via respective beams of multiple beams (for example, from the beams 160a of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices (for example, a network node 110 and/or UEs 120). For example, the one or more devices may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some examples, a UE 120 may implement power saving features, such as for UEs 120 in an RRC connected mode, an RRC idle mode, or an RRC inactive mode. Power saving features may include, for example, relaxed radio resource monitoring (such as for devices operating in low mobility or in good radio conditions), discontinuous reception (DRX), reduced PDCCH monitoring during active times, and/or power-efficient paging reception.

In some examples, a UE 120 may operate in association with a DRX configuration (for example, indicated to the UE 120 by a network node 110). DRX operation may enable the UE 120 to enter a sleep mode at various times while in the coverage area of a network node 110 to reduce power consumption for conserving battery resources, among other examples. The DRX configuration generally configures the UE 120 to operate in association with a DRX cycle. The UE 120 may repeat DRX cycles with a configured periodicity according to the DRX configuration. A DRX cycle may include a DRX on duration during which the UE 120 is in an awake mode or in an active state. A DRX cycle may also include one or more durations (sometimes referred to as “DRX off durations”) during which the UE 120 may operate in an inactive state. The one or more durations may be opportunities for the UE 120 to enter a DRX sleep mode in which the UE 120 may refrain from monitoring for communications from a network node 110. Additionally or alternatively, the UE 120 may deactivate one or more antennas, RF chains, and/or other hardware components or devices while operating in the DRX sleep mode.

The time during which the UE 120 is configured to be in an active state during a DRX on duration may be referred to as an active time, and the time during which the UE 120 is configured to be in an inactive state, such as during a DRX sleep duration, may be referred to as an inactive time. During a DRX on duration, the UE 120 may monitor for downlink communications from one or more network nodes 110. If the UE 120 does not detect and/or does not successfully decode any downlink communications during the DRX on duration, the UE 120 may enter a DRX sleep mode for the inactive time duration at the end of the DRX on duration. If the UE 120 detects and/or successfully decodes a downlink communication during the DRX on duration, the UE 120 may remain in the active state for the duration of a DRX inactivity timer (which may extend the active time). The UE 120 may start the DRX inactivity timer at a time at which the downlink communication is received. The UE 120 may remain in the active state until the DRX inactivity timer expires, at which time the UE 120 may transition to the sleep mode for an inactive time duration. Additionally or alternatively, the UE 120 may use a DRX cycle referred to as an extended DRX (eDRX) cycle, such as for use cases that are tolerant to latency. An eDRX cycle may include a relatively longer inactive time relative to a baseline DRX cycle (for example, an eDRX cycle may have a lower ratio of active time to inactive time). Some aspects described herein provide adjustment of DRX timers, such as a DRX inactivity timer, a HARQ RTT timer, or a HARQ retransmission timer, using dynamic signaling such as a MAC-CE or DCI.

FIG. 2 is a diagram illustrating an example disaggregated network node architecture 200 in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a Non-RT RIC 250 associated with a Service Management and Orchestration (SMO) Framework 260 and/or a Near-RT RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

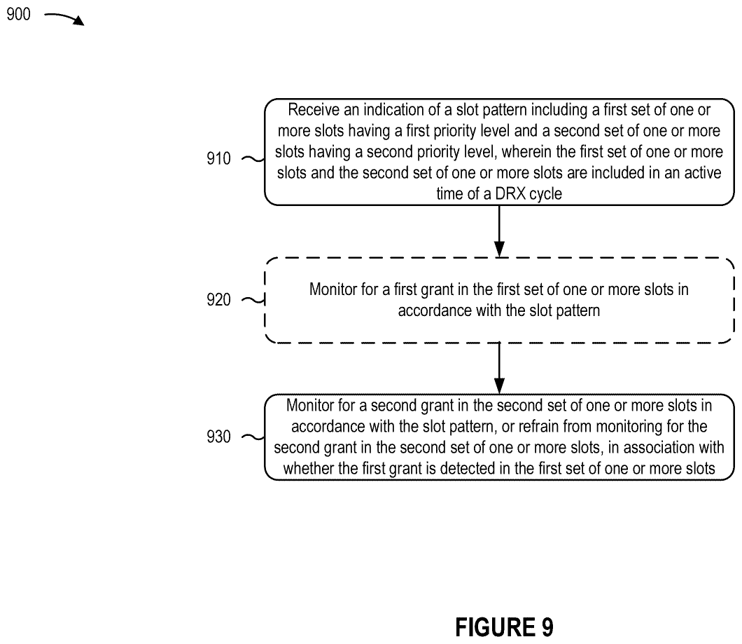

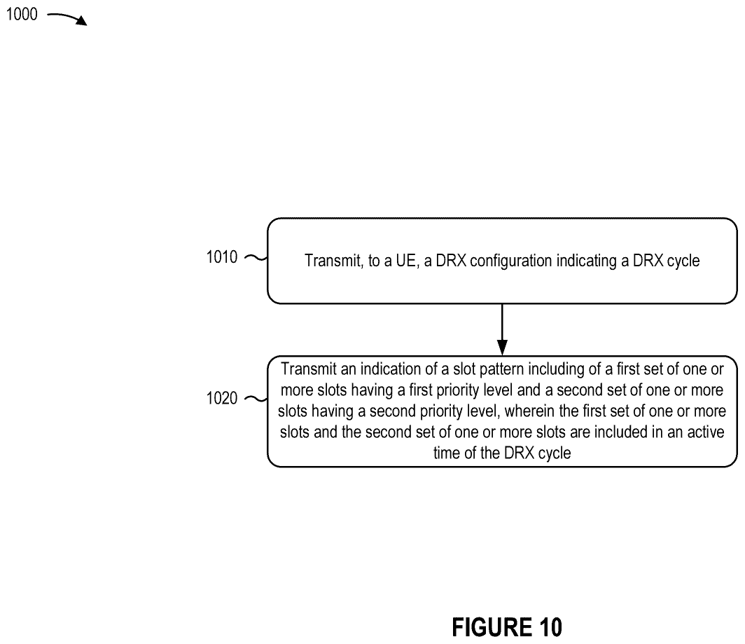

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with slot prioritization for C-DRX, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, UE 120 may include means for receiving an indication of a slot pattern including a first set of one or more slots having a first priority level and a second set of one or more slots having a second priority level, means for monitoring for a first grant in the first set of one or more slots in accordance with the slot pattern, means for monitoring for a second grant in the second set of one or more slots in accordance with the slot pattern, means for refraining from monitoring for the second grant in the second set of one or more slots, means for receiving a DRX configuration associated with the DRX cycle and indicating a timer parameter, means for receiving an adjustment to the timer parameter, and/or means for monitoring for a grant according to the adjustment. In some aspects, such means may include one or more components of UE 120 described in connection with FIG. 1, such as processing system 140, or the like.

In some aspects, network node 110 may include means for transmitting, to a UE, a DRX configuration indicating a DRX cycle, means for transmitting an indication a slot pattern including of a first set of one or more slots having a first priority level and a second set of one or more slots having a second priority level, or the like. In some aspects, such means may include one or more components of network node 110 described in connection with FIG. 1, such as processing system 145, or the like.

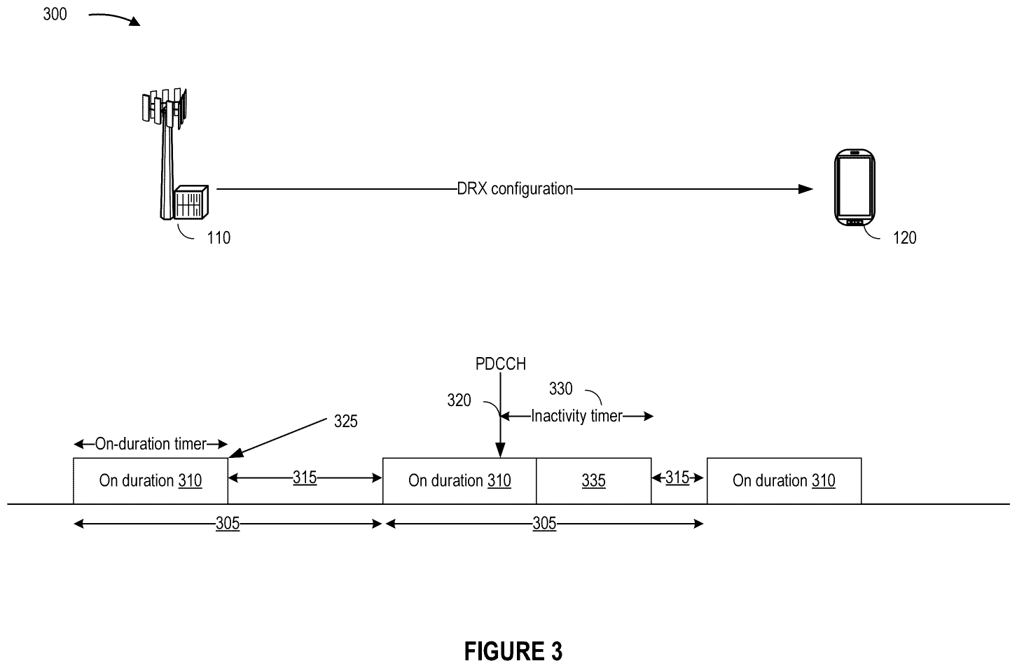

FIG. 3 is a diagram illustrating an example 300 of a DRX configuration.

As shown in FIG. 3, a network node 110 may transmit, and a UE 120 may receive, a DRX configuration. The DRX configuration may configure a DRX cycle 305. A DRX cycle 305 may include a DRX on duration 310 (for example, during which a UE 120 is awake or in an active state) and an opportunity to enter a DRX sleep state 315. The time during which the UE 120 is configured to be in an active state during the DRX on duration 310 plus any extension of the DRX on duration 310 due to an inactivity timer may be referred to as an active time, and the time during which the UE 120 is configured to be in the DRX sleep state 315 may be referred to as an inactive time or a DRX off duration. The UE 120 may monitor a downlink control channel (for example, a PDCCH) during the active time and may refrain from monitoring the downlink control channel during the inactive time.

During the DRX on duration 310, the UE 120 may monitor a control channel, as shown by reference number 320. For example, the UE 120 may monitor the control channel for control information (for example, DCI) pertaining to the UE 120. If the UE 120 does not detect and/or successfully decode any control channel communications intended for the UE 120 during the DRX on duration 310, then the UE 120 may enter the sleep state 315 (for example, for the inactive time) at the end of the DRX on duration 310, as shown by reference number 325. In this way, the UE 120 may conserve battery power and reduce power consumption. As shown, the DRX cycle 305 may repeat with a configured periodicity according to the DRX configuration.

If the UE 120 detects and/or successfully decodes a control channel communication intended for the UE 120, then the UE 120 may remain in an active state (for example, awake) for the duration of a DRX inactivity timer 330 (for example, which may extend into the configured inactive time of the current DRX cycle). The DRX inactivity timer 330 may be referred to herein as a timer parameter. The UE 120 may start the DRX inactivity timer 330 at a time at which the control channel communication is received (for example, in a TTI in which the control channel communication is received, such as a slot or a subframe). The UE 120 may remain in the active state until the DRX inactivity timer 330 expires, at which time the UE 120 may enter the sleep state 315 (for example, for the remainder of the inactive time of the current DRX cycle), as shown by reference number 335. During the duration of the DRX inactivity timer 330, the UE 120 may continue to monitor for control channel communications, may obtain a downlink data communication (for example, on a data channel such as a PDSCH) scheduled by the control channel communication, and/or may prepare and/or transmit a communication (for example, on a PUSCH and/or a PSSCH) scheduled by the control channel communication. The UE 120 may restart the DRX inactivity timer 330 after each detection of a control channel communication for the UE 120 for an initial transmission (for example, but not for a retransmission). By operating in this manner, the UE 120 may conserve battery power and reduce power consumption by entering the sleep state 315.

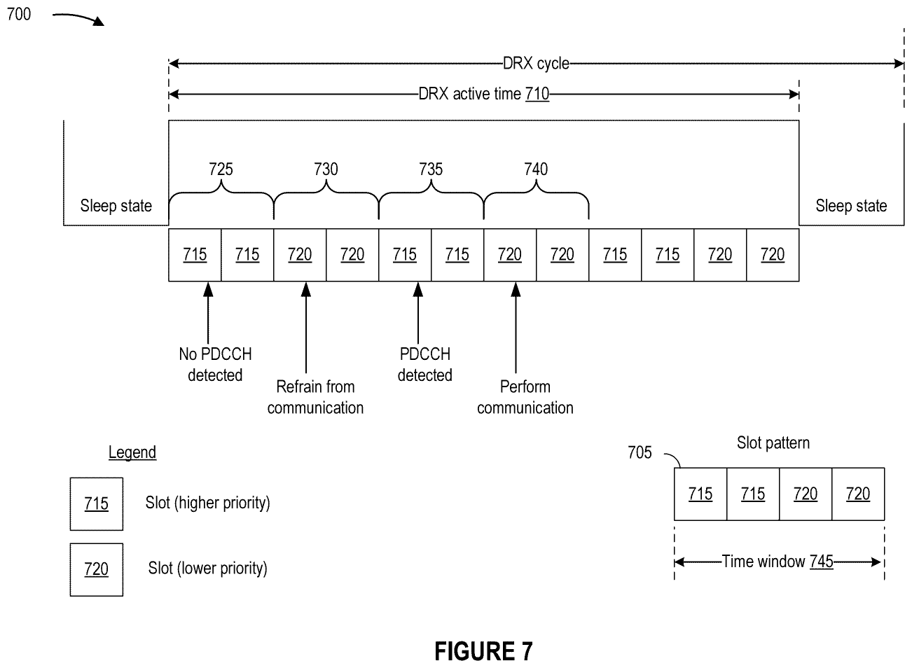

In some examples, a DRX configuration may incorporate or be associated with a slot pattern. FIG. 7 provides additional description of such a slot pattern.

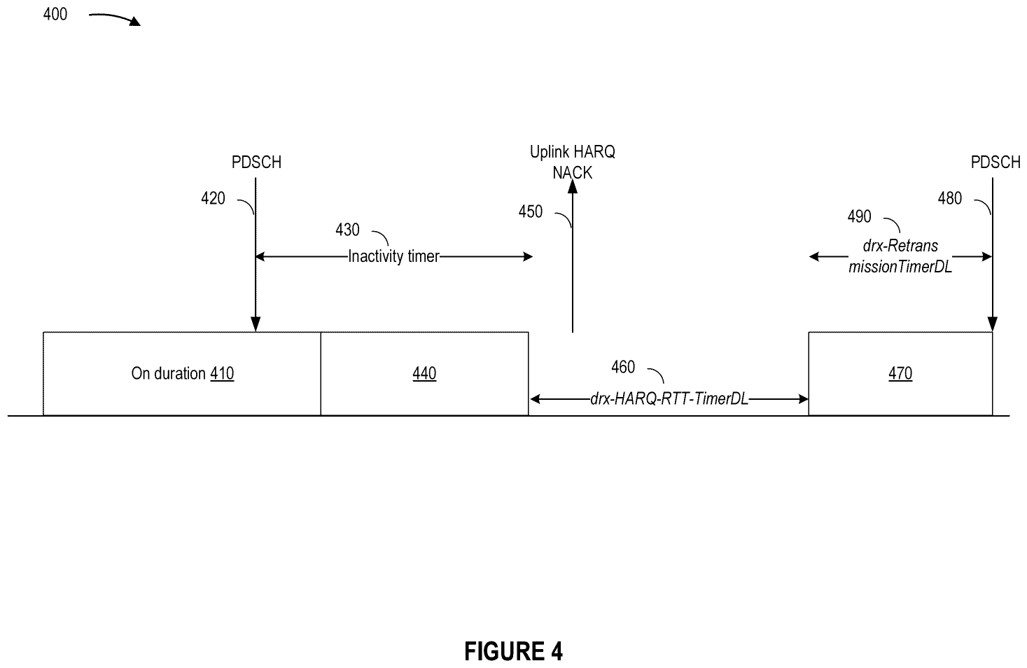

FIG. 4 is a diagram illustrating an example 400 of a downlink HARQ RTT timer and a downlink HARQ retransmission timer. The downlink HARQ RTT timer and the downlink HARQ retransmission timer may each be referred to herein as timer parameters. The operations of example 400 may be performed by a UE, such as UE 120.

Example 400 includes a DRX on duration 410, which may be an example of DRX on duration 310 described with respect to FIG. 3. As shown, the UE may receive a PDSCH 420 during the DRX on duration 410. Thus, the UE may start a DRX inactivity timer 430, as described with regard to FIG. 3, and may remain in an active state during the time interval shown by reference number 440.

The UE may fail to receive (for example, may fail to decode) the PDSCH 420. Thus, the UE may transmit an uplink HARQ NACK 450. Upon transmitting the uplink HARQ NACK 450, the UE may start a downlink HARQ RTT timer 460 (which may be defined by a parameter drx-HARQ-RTT-TimerDL). In some examples, the UE may enter a sleep state (such as sleep state 315) during the downlink HARQ RTT timer 460.

Upon expiration of the downlink HARQ RTT timer 460, the UE may enter an active state 470. The UE may remain in the active state 470 until a retransmission 480 of the PDSCH 420 is received, or until expiration of a downlink HARQ retransmission timer 490. For example, upon receiving the retransmission 480, the UE may stop the downlink HARQ retransmission timer 490 and may enter a sleep state (such as sleep state 315) until a next DRX on duration 410. The downlink HARQ retransmission timer 490 may be defined by a parameter such as drx-RetransmissionTimerDL.

Some aspects described herein provide dynamic adjustment of the downlink HARQ RTT timer 460 and/or the downlink HARQ retransmission timer 490.

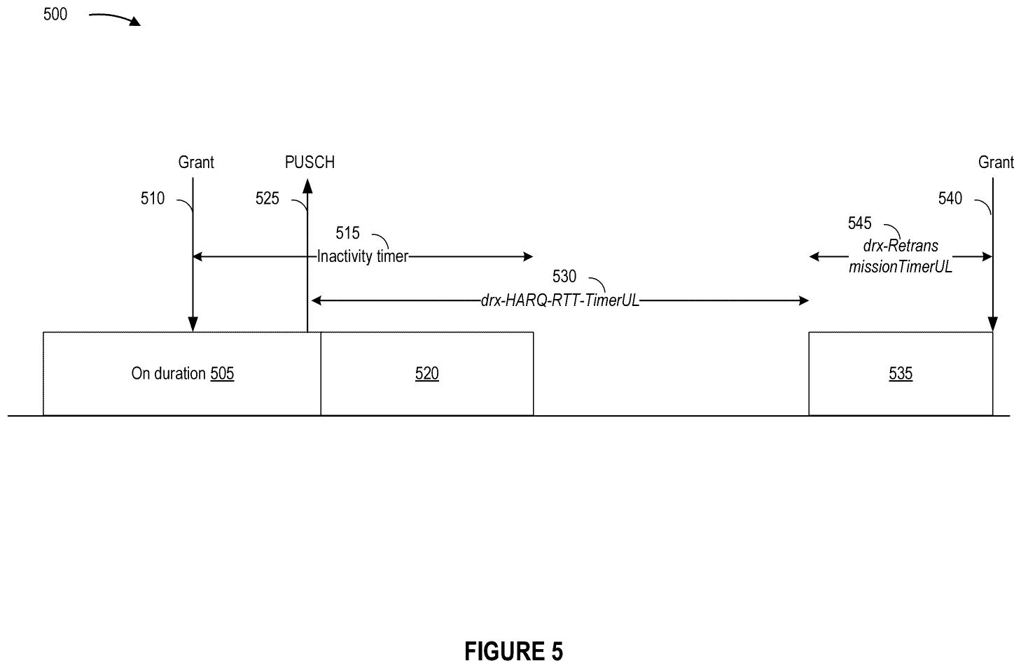

FIG. 5 is a diagram illustrating an example 500 of an uplink HARQ RTT timer and an uplink HARQ retransmission timer. The uplink HARQ RTT timer and the uplink HARQ retransmission timer may each be referred to herein as timer parameters. The operations of example 500 may be performed by a UE, such as UE 120.

Example 500 includes a DRX on duration 505, which may be an example of DRX on duration 310 described with respect to FIG. 3. As shown, the UE may receive a grant 510 (such as a PDCCH carrying DCI with the grant) during the DRX on duration 505. Thus, the UE may start a DRX inactivity timer 515, as described with regard to FIG. 3, and may remain in an active state during the time interval shown by reference number 520.

During the DRX on duration 505 or the time interval shown by reference number 520, the UE may transmit a PUSCH 525 in accordance with the grant 510.

Upon transmitting the PUSCH 525, the UE may start an uplink HARQ RTT timer 530 (which may be defined by a parameter drx-HARQ-RTT-TimerUL). In some examples, the UE may enter a sleep state (such as sleep state 315) during the uplink HARQ RTT timer 530.

Upon expiration of the uplink HARQ RTT timer 530, the UE may enter an active state 535. The UE may remain in the active state 535 until a grant 540 (or another form of retransmission request) for a retransmission of the PUSCH 525 is received, or until expiration of an uplink HARQ retransmission timer 545. For example, upon receiving the grant 540 (or the other form of retransmission request), the UE may stop the uplink HARQ retransmission timer 545 and may prepare for retransmission of the PUSCH 525. The uplink HARQ retransmission timer 545 may be defined by a parameter such as drx-RetransmissionTimerUL.

Some aspects described herein provide dynamic adjustment of the uplink HARQ RTT timer 530 and/or the uplink HARQ retransmission timer 545.

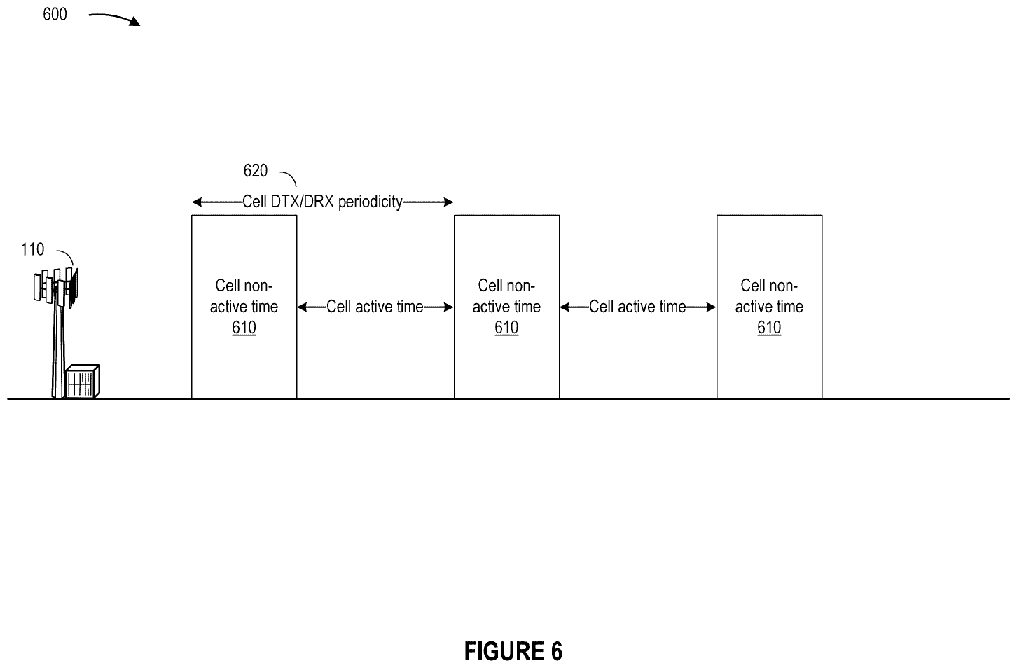

FIG. 6 is a diagram illustrating an example 600 of cell DTX/DRX. Cell DTX/DRX provides a way for a network node 110 to periodically enter a sleep state during a cell non-active time 610. During a cell non-active time 610, transmission or reception of certain types of downlink and/or uplink signals may be restricted. For example, a UE may not be expected to transmit or receive certain types of downlink and/or uplink signals during a cell non-active time 610, which gives the network node 110 an opportunity to save power be entering a sleep state. The network node 110 may enter the sleep state according to a periodicity 620, which may be referred to as a cell DTX/DRX periodicity. After the end of a cell non-active time 610, the network node 110 may enter a cell active time, and may perform transmission or reception.

Examples of downlink signals or channels that may be restricted or expected not to be transmitted or received during a cell non-active time 610 may include any one or more of: a channel state information reference signal, a tracking reference signal, a positioning reference, a PDCCH scrambled with a UE-specific radio network temporary identifier (RNTI), a PDCCH in a type 3 common search space (that is, a common search space for DCI formats with a cyclic redundancy check (CRC) scrambled by an interruption RNTI (INT-RNTI), a slot format indicator RNTI (SFI-RNTI), a transmit power control (TPC) for PUSCH RNTI (TPC-PUSCH-RNTI), a TPC for PUCCH RNTI (TPC-PUCCH-RNTI), a TPC for sounding reference signal (SRS) RNTI (TPC-SRS-RNTI) a cell RNTI (C-RNTI) for a primary cell, or a cell-specific RNTI (CS-RNTI) for a primary cell), or a semi-persistent scheduling (SPS) PDSCH. Examples of uplink signals or channels that may be restricted or expected not to be transmitted or received during a cell non-active time 610 may include any one or more of a scheduling request (SR), a periodic CSI report, a semi-persistent CSI report, a periodic sounding reference signal (SRS), a semi-persistent SPS, or a configured grant PUSCH.

While cell non-active times 610 provide opportunities for a network node 110 to enter a sleep state, it may not always be practical for the network node 110 to enter the sleep state. For example, a network node 110 may serve multiple UEs. Each of these UEs may have a respective C-DRX configuration (such as DRX configurations described with respect to FIGS. 3, 4, and 5). While the network node 110 can align the DRX on durations and inactive times of these UEs, the operation of HARQ RTT timers and inactivity timers may cause communications of some UEs to extend into a cell non-active time 610. In this situation, the network node 110 may not be able to fully utilize a cell non-active time 610, thereby reducing the power savings achieved with cell DTX/DRX.

Furthermore, as mentioned, many communications between UEs and networks may be small data communications (such as small data transfers or other transmissions or receptions having lower than a threshold data size). However, even such small communications may be scheduled using PDCCHs, and PDCCHs may generally block other communications on the PDCCH resources (since PDCCHs are generally prioritized over other communications). This may lead to a high PDCCH blocking ratio (where a PDCCH blocking ratio is defined as the rate of occurrences of the PDCCH blocking a UE from being scheduled while the PDSCH or PUSCH has available resources), even at relatively low levels of network utilization such as 30% physical resource block usage.

FIG. 7 is a diagram illustrating an example 700 of a slot pattern 705 for a DRX active time 710. In some aspects, the DRX active time 710 may include a DRX on duration (such as DRX on duration 310). In some aspects, the DRX active time 710 may additionally include an active time associated with an inactivity timer such as DRX inactivity timer 330.

As shown, the slot pattern 705 may indicate a first set of one or more slots 715 and a second set of one or more slots 720. The first set of one or more slots 715 may be composed of slots 715 and the second set of one or more slots 720 may be composed of slots 720. In some aspects, the first set of one or more slots 715 may be associated with a first priority level and the second set of one or more slots 720 may be associated with a second priority level. The first priority level may be a higher priority level than the second priority level. Operations associated with priority levels are described in more detail below.

In some aspects, a first slot pattern 705 may be configured for uplink communications and a second slot pattern 705 may be configured for downlink communications. This may improve communication efficiency in cases where there is more uplink traffic than downlink traffic, or more downlink traffic than uplink traffic.

As shown, in some examples, for a given occurrence of the slot pattern 705, the first set of one or more slots 715 may occur earlier in the DRX active time 710 or a time window 745 than the second set of one or more slots 720. This may be referred to as “frontloading” the first set of one or more slots 715 in the DRX active time 710.

A UE (such as UE 120) may monitor for a grant (such as an uplink or downlink grant) in a first set of one or more slots 715. If the UE receives (for example, detects) a grant in the first set of one or more slots 715, the UE may perform a communication in a second set of one or more slots 720. For example, the UE may monitor for another grant in the second set of one or more slots 720. As another example, the UE may transmit or receive a communication scheduled by the grant that was received in the first set of one or more slots 715. As another example, the UE may perform a configured communication in the second set of one or more slots 720.

If the UE does not receive a grant in the first set of one or more slots 715 (for example, if the UE fails to detect the grant), the UE may refrain from performing a communication in the second set of one or more slots 720. For example, the UE may refrain from performing the communication in the second set of one or more slots 720 in accordance with failing to detect the grant. In some examples, refraining from performing a communication may include skipping monitoring of a PDCCH (for example, cancelling monitoring of the PDCCH). In some examples, refraining from performing a communication may include cancelling, delaying, or rescheduling an uplink transmission, such as a periodic uplink transmission. In some examples, refraining from performing a communication may include cancelling reception of a downlink communication, such as a periodic downlink communication. In some aspects, the UE may enter a sleep state during the second set of one or more slots 720. The sleep state may include, for example, the sleep state 315. In some aspects, a network node (such as network node 110) may also enter a sleep state (such as a sleep state associated with a cell non-active time 610) during the second set of one or more slots 720. Thus, the UE and the network node may save power by entering a sleep state during part of the DRX active time 710.

In some aspects, the slot pattern 705 may be cyclical. For example, the slot pattern 705 may reoccur in time. Thus, multiple occurrences of the first set of one or more slots 715 may be multiplexed with multiple occurrences of the second set of one or more slots 720 in time. In some aspects, if the UE does not detect a PDCCH in a first set of one or more slots 715 shown by reference number 725, the UE may enter a sleep state in a second set of one or more slots shown by reference number 730. The UE may then monitor a PDCCH in a subsequent first set of one or more slots 715 shown by reference number 735. If the UE detects a PDCCH in the subsequent first set of one or more slots 715 shown by reference number 735, the UE may perform a communication in a subsequent second set of one or more slots 720 shown by reference number 740.

The slot pattern 705 may be beneficial for purposes of aligning communications across multiple UEs. For example, the network node may configure multiple UEs with the slot pattern 705, such that first sets of one or more slots 715 are aligned across the multiple UEs. Aligning the slot pattern 705 in this fashion increases the likelihood that the network node can enter a sleep state during second sets of one or more slots 720, and during an inactive time, thereby saving power at the network node. Furthermore, aligning the slot pattern 705 in this fashion reduces control channel element (CCE) usage by concentrating PDCCH transmissions in a relatively smaller number of slots than a full DRX on duration that does not implement a slot pattern 705. Thus, PDCCH blocking is reduced, thereby increasing bandwidth. Furthermore, the slot pattern 705 may reduce overhead relative to other schemes for reducing PDCCH blocking, such as transmission of a dummy DCI without a grant to indicate a PDCCH skip, because no additional transmission is used to indicate that the second set of one or more slots 720 will not be used for communication between the network node and the UE.

The slot pattern 705 of example 700 is described with regard to two priority levels. In some aspects, a slot pattern may include more than two priority levels. For example, a slot pattern may include three priority levels: a high priority level, an intermediate priority level, and a low priority level. If a UE receives a grant in a slot with a high priority level, the UE may monitor for or otherwise perform a communication in a slot with an intermediate priority level. If no communication occurs in the slot with the intermediate priority level, the UE may refrain from performing a communication in a slot with the low priority level. If a communication occurs in the slot with the intermediate priority level, the UE may monitor for or otherwise perform a communication in the slot with the low priority level. In some aspects, these slots may be arranged in an order based on corresponding priority levels. For example, the slot with the high priority level may occur earliest in the slot pattern, the slot with the low priority level may occur latest in the slot pattern, and the slot with the intermediate priority level may occur between the slot with the high priority level and the slot with the low priority level.

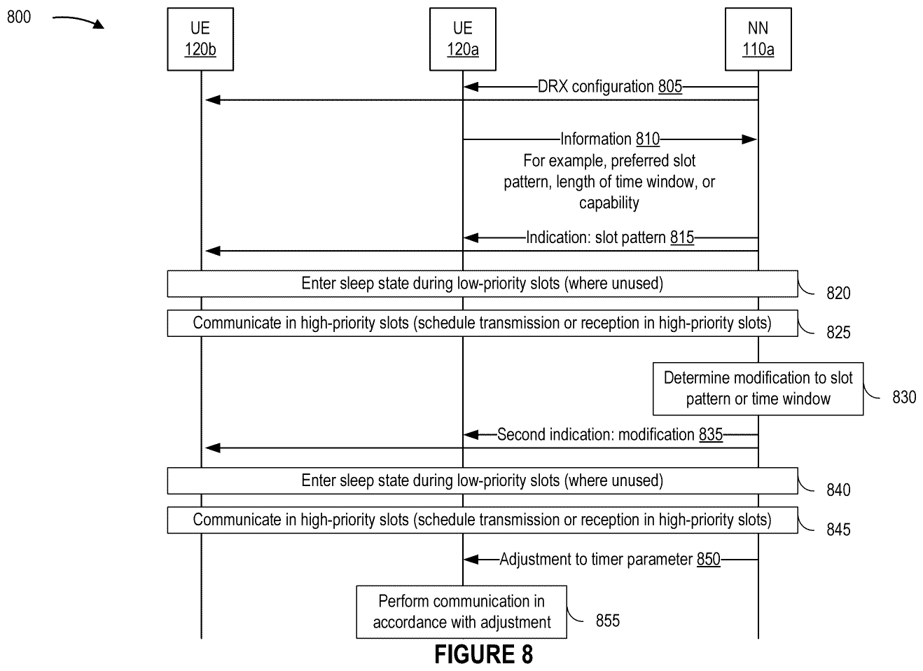

As shown, the slot pattern 705 includes multiple occurrences of the slot pattern 705, and each occurrence of the slot pattern 705 may include a first set of one or more slots 715 and a second set of one or more slots 720. Each occurrence of the slot pattern 705 may be included in a respective time window 745. The length of the time window 745 may be configurable and/or adjustable, as described in connection with FIG. 8.

FIG. 8 is a diagram illustrating an example 800 of signaling associated with configuring a slot pattern for a DRX active time. Example 800 includes a network node 110, a first UE 120a, and a second UE 120b.

As shown, the network node 110 may transmit, and the first UE 120a and/or second UE 120b may receive, a DRX configuration 805. The DRX configuration 805 may be an example of the DRX configuration described with regard to FIG. 3. In some aspects, the network node 110 may configure a single UE 120 with the DRX configuration 805. The DRX configuration 805 may include a set of DRX parameters, such as a set of timer parameters (including, for example, a DRX inactivity timer, a downlink HARQ RTT timer, an uplink HARQ RTT timer, a downlink HARQ retransmission timer, an uplink HARQ retransmission timer, or another form of timer relevant to a DRX cycle), a DRX cycle length, or a DRX on duration length. In some aspects, the network node 110 may transmit the DRX configuration 805 via RRC signaling.

As shown, in some aspects, a UE 120 (in this example, the first UE 120a) may transmit, and the network node 110 may receive, information 810. In some aspects, the information 810 may indicate a preferred slot pattern. In some aspects, the information 810 may indicate a length of a time window, such as a preferred length of a time window. In some aspects, the information 810 may include capability information indicating support for adjustment of a timer parameter of the DRX configuration.

In some aspects, the information 810 may indicate a preferred slot pattern. For example, the UE 120 may transmit an indication of a preference for a slot pattern. This indication may indicate, for example, a number of slots belonging to a first set of one or more slots, a number of slots belonging to a second set of one or more slots, an arrangement of slots of the first set and/or slots of the second set, or a number of priority levels (or equivalently, sets of slots) to provide in the slot pattern.

In some aspects, the information 810 may indicate a length of a time window, such as time window 745. For example, the information 810 may indicate a number of slots to be included in a time window. As another example, the information 810 may indicate a number of time windows to be included in a DRX on duration or active time.

In some aspects, the UE 120 may determine the information 810. For example, the UE 120 may determine the information 810 in accordance with traffic information. The traffic information may include, for example, a distribution of PDCCH or other communications in time, buffered data at the UE, a number of transmissions to be performed by the UE, or similar information. For example, the UE 120 may determine that grants are expected in a later portion of a DRX on duration according to the traffic information, and may transmit information 810 that indicates a preference for a slot pattern with a first set of one or more slots in the later portion of the DRX on duration.

In some aspects, the UE 120 may determine the information 810 using an artificial intelligence or machine learning (AI/ML) functionality. An AI/ML functionality may include a model or group of models that perform a function. In the present example, the function may be determination of information 810 (such as a preferred slot pattern or a length of a time window). The AI/ML functionality may receive, as input, information such as traffic information, the DRX configuration, a configured slot pattern, or a combination thereof. The AI/ML functionality may output information 810, such as a preferred slot pattern, a length of a time window, or a combination thereof. The AI/ML functionality may be trained on a dataset of traffic information, DRX configurations, and/or slot patterns, with corresponding information 810, using a loss function. The AI/ML functionality may later be updated, for example, based on observations regarding reported information 810 (or configured slot patterns in response to information 810) and corresponding traffic information, DRX configurations, and/or slot patterns.

In some aspects, the UE 120 may transmit the information 810 prior to receiving the DRX configuration 805. In some aspects, the UE 120 may transmit the information 810 after receiving the DRX configuration 805. In some aspects, the UE 120 may transmit the information 810 after receiving an indication 815 of a slot pattern. For example, the UE 120 may request a change to the slot pattern.

In some aspects, the information 810 may include capability information indicating support for adjustment of a timer parameter of the DRX configuration. For example, the capability information may indicate that a UE 120 supports one or more types of adjustment. In such examples, the capability information may indicate whether the UE 120 supports incremental change to a length of a timer indicated by a timer parameter. Additionally or alternatively, the capability information may indicate whether the UE 120 supports resetting a timer indicated by the timer parameter. Additionally or alternatively, the capability information may indicate a supported adjustment, such as a granularity of adjustment, a maximum value to which a timer parameter can be adjusted, or a minimum value to which the timer parameter can be adjusted.

As shown, the network node 110 may transmit, and the UE 120a and the UE 120b may receive, an indication 815 of a slot pattern. The slot pattern may be an example of slot pattern 705, described in connection with FIG. 7. As just one example, the slot pattern may indicate an alternating pattern of slots with a high priority level and slots with a low priority level during a C-DRX on duration. In some aspects, the network node 110 may transmit the indication 815 via RRC signaling, such as an RRC reconfiguration message. For example, the network node 110 may transmit the indication 815 in connection with a call setup or a handover of the UE 120a or the UE 120b to the network node 110. In some aspects, the network node 110 may indicate a common slot pattern (such as the same slot pattern) for a group of UEs. For example, the network node 110 may indicate a common slot pattern for each UE 120 associated with (such as connected to) the network node 110.

By providing a common slot pattern (such as the same slot pattern) to multiple UEs 120, the network node 110 and the multiple UEs 120 may each be enabled to enter a sleep state more frequently than if different slot patterns were provided, as shown in an operation 820. In some aspects, the network node 110 may align a cell non-active time 610 with a set of one or more second slots in which the multiple UEs 120 are in the sleep state.

In some aspects, the network node 110 may buffer or delay data (such as small data transmissions, which may represent data transmissions of lower than a threshold size) across the multiple UEs 120. In an operation 825, the network node 110 may schedule transmission or reception of the buffered or delayed data during a first set of one or more slots (such as high priority slots) of the slot pattern for each of the multiple UEs 120. The network node 110 may perform this scheduling, for example, in a frequency division multiplexed (FDMed) fashion in which multiple transmissions or receptions are overlapped in time and transmitted on different frequency resources. As another example, the network node 110 may schedule the transmission or reception using multi-user MIMO, in which multiple PUSCHs or multiple PDSCHs are transmitted in a MIMO fashion across the multiple UEs 120.

In an operation 830, the network node 110 may determine a modification to the slot pattern or the time window. For example, the network node 110 may determine the modification based at least in part on a traffic load. In the case of a high traffic load, the network node 110 may configure a larger number of slots of the slot pattern to have a higher priority level. In the case of a low traffic load, the network node 110 may configure a larger number of slots of the slot pattern to have a lower priority level. As another example, the network node 110 may determine the modification based at least in part on a number of connected UEs 120 (such as a number of UEs 120 with active RRC connections). In the case of a high traffic load, the network node 110 may configure a longer time window. In the case of a low traffic load, the network node 110 may configure a shorter time window. As another example, the network node 110 may determine the modification based at least in part on an uplink physical resource block (PRB) usage, a downlink PRB usage, or a combination (such as a ratio) thereof. For example, if uplink PRB usage is higher than downlink PRB usage, the network node 110 may configure an uplink slot pattern with a longer time window or more high-priority slots than a downlink slot pattern. As another example, the network node 110 may determine the modification based at least in part on a latency parameter of an application. For example, if application traffic is associated with a short latency requirement (that is, a lower latency), the network node 110 may configure a slot pattern with a larger number of high-priority slots or a shorter time window.

As shown, the network node 110 may transmit, and the UE 120a and the UE 120b may receive, a second indication 835. The second indication 835 may include the modification determined in connection with the operation 830. For example, the second indication 835 may include a modification of the slot pattern. Additionally or alternatively, the second indication 835 may include a modification of a length of the time window. As shown, in an operation 840, the network node 110, the first UE 120a, and/or the second UE 120b may enter a sleep state in slots that include no transmission or reception according to the modification. As shown, in an operation 845, the network node 110, the first UE 120a, and/or the second UE 120b may wake up for slots of the first set of one or more slots, as indicated by the modification to the slot pattern.

In an operation 850, the network node 110 may transmit, and the UE 120a may receive, an adjustment to a timer parameter. The timer parameter may include any one or more of the timer parameters described with respect to FIGS. 3, 4, and/or 5. In some aspects, the adjustment to the timer parameter may be in accordance with capability information provided in the information 810. For example, the adjustment may be an adjustment supported by the UE 120a or the UE 120b. The network node 110 may transmit the adjustment via dynamic signaling, such as DCI or a MAC-CE.

In some aspects, the adjustment to the timer parameter may not be a reconfiguration of the timer parameter. For example, the adjustment to the timer parameter may indicate an incremental change to the timer parameter, which is different than a reconfiguration that explicitly indicates an updated value of the timer parameter. Indicating the incremental change may reduce overhead and latency relative to explicitly reconfiguring the timer parameter.

In some aspects, the network node 110 may transmit, and the UE 120a may receive (such as prior to receiving the adjustment), a configuration relating to the adjustment. For example, the configuration relating to the adjustment may be included in the DRX configuration 805 or may be separate from the DRX configuration 805. In some aspects, the configuration may indicate that a feature associated with the adjustment is activated. For example, the configuration may enable adjustment of the timer parameter in the operation 840. Additionally or alternatively, the configuration may indicate an increment associated with the adjustment. For example, the adjustment may incrementally increase or decrease the timer parameter, and the configuration may indicate a granularity of the incremental increase or decrease. As a more specific example, the configuration may indicate that a first value (such as a set of bits “10”) indicates to increment the length of the timer parameter by 100 ms, and a second value (such as a set of bits “11”) indicates to decrement the length of the timer parameter by 10 ms. Additionally or alternatively, the configuration may indicate a mapping between a value and an adjustment. For example, a first value (such as a set of bits “00”) may be mapped to an adjustment to reset a timer, and a second value (such as a set of bits “01”) may be mapped to an adjustment that does not reset the timer.

As mentioned, in some aspects, the adjustment may indicate to reset a timer associated with a timer parameter. For example, the UE 120a may have a configured DRX inactivity timer length of 100 ms, and this DRX inactivity timer may have a current time of 35 ms. In this example, the adjustment to reset the timer may reset the DRX inactivity timer to 0 ms, and the DRX inactivity timer may then proceed to count to 100 ms.

In some aspects, the adjustment may indicate to increment a timer parameter. For example, the UE 120a may have a configured DRX inactivity timer length of 100 ms. The adjustment may indicate to increment the DRX inactivity timer length by 100 ms. The UE 120a may change the DRX inactivity timer length from 100 ms to 200 ms in accordance with the adjustment.

In some aspects, the adjustment may indicate to decrement a timer parameter. For example, the UE 120a may have a configured DRX inactivity timer length of 100 ms. The adjustment may indicate to decrement the DRX inactivity timer length by 10 ms. The UE 120a may change the DRX inactivity timer length from 100 ms to 90 ms in accordance with the adjustment.

As shown, in an operation 855, the UE 120a may perform a communication in accordance with the adjustment. For example, the UE 120a may monitor for a PDCCH in a DRX on duration in accordance with the adjustment. As another example, the UE 120a may monitor for a PDCCH in a first set of one or more slots in accordance with the adjustment. As another example, the UE 120a may extend or shorten a DRX on duration in accordance with the adjustment. As another example, the UE 120a may reset a length of a DRX on duration, a HARQ RTT timer, or a HARQ retransmission timer in accordance with the adjustment.

In some aspects, example 800 may include only transmission of the DRX configuration 805, (optionally) transmission of the information 810, adjustment of the timer parameter in the operation 850, and communication in the operation 855.

Alternatively, in some aspects, example 800 may exclude operation 850 and communication in the operation 855. Alternatively, in some aspects, example 800 may exclude the determination at operation 830, the second indication 835, the operations 840 and 845, the adjustment at operation 850, and the communication at operation 855.

FIG. 9 is a diagram illustrating an example process 900 performed, for example, by a UE. Example process 900 is an example where the UE (for example, a UE 120) performs operations associated with slot prioritization for connected mode discontinuous reception.

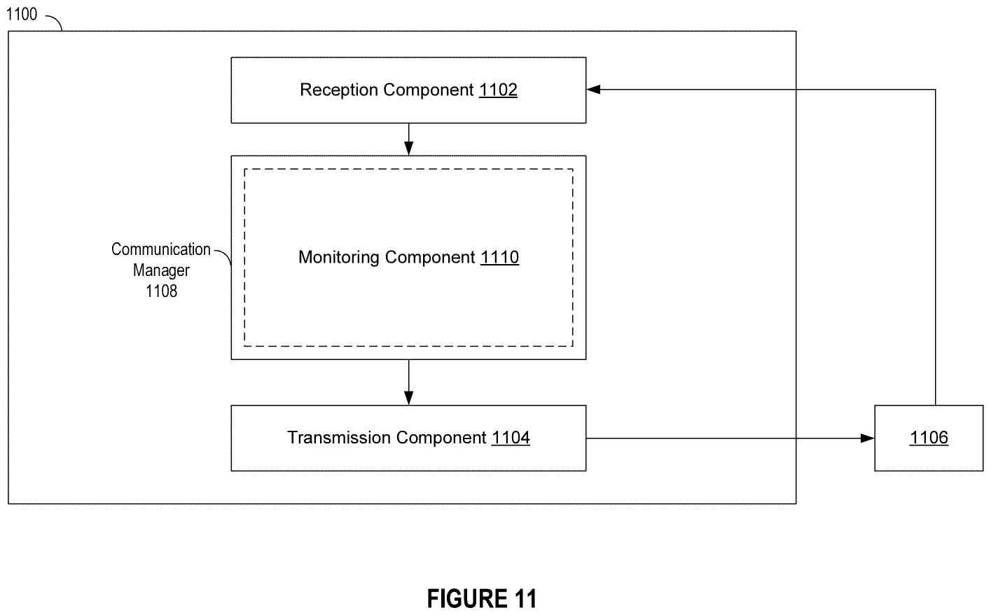

As shown in FIG. 9, in some aspects, process 900 may include receiving an indication of a slot pattern including a first set of one or more slots having a first priority level and a second set of one or more slots having a second priority level, wherein the first set of one or more slots and the second set of one or more slots are included in an active time of a DRX cycle (block 910). For example, the UE (for example, using communication manager 1108 and/or reception component 1102, depicted in FIG. 11) may receive an indication of a slot pattern including a first set of one or more slots and a second set of one or more slots, wherein the first set of one or more slots and the second set of one or more slots are included in an active time of a DRX cycle, as described above. The first set of one or more slots may have a first (higher) priority level, and the second set of one or more slots may have a second (lower) priority level.

As further shown in FIG. 9, in some aspects, process 900 may optionally include monitoring for a first grant in the first set of one or more slots in accordance with the slot pattern (block 920). For example, the UE (for example, using communication manager 1108, reception component 1102, and/or monitoring component 1110, depicted in FIG. 11) may monitor for a first grant (such as a PDCCH grant) in the first set of one or more slots in accordance with the slot pattern, as described above.

As further shown in FIG. 9, in some aspects, process 900 may include monitoring for a second grant in the second set of one or more slots in accordance with the slot pattern, or refraining from monitoring for the second grant in the second set of one or more slots, in association with whether the first grant is detected in the first set of one or more slots (block 930). For example, the UE (for example, using communication manager 1108, reception component 1102, and/or transmission component 1104, depicted in FIG. 11) may monitor for a grant in the second set of one or more slots in accordance with the slot pattern, or refrain from monitoring for the grant in the second set of one or more slots, in association with whether the first grant is detected in the first set of one or more slots, as described above.

Process 900 may include additional aspects, such as any single aspect or any combination of aspects described below and/or in connection with one or more other processes described elsewhere herein.

In some aspects, process 900 includes monitoring for the first grant in the first set of one or more slots in association with the first set of one or more slots having the first priority level, and monitoring for the second grant in the second set of one or more slots is associated with the second set of one or more slots having the second priority level.

In some aspects, process 900 includes transmitting, prior to receiving the indication, capability information indicating support for the slot pattern with the first priority level and the second priority level, wherein the indication is in accordance with the capability information.

In some aspects, the slot pattern is common to a plurality of UEs including the UE.

In some aspects, process 900 includes enter a sleep state during refraining from monitoring the second grant in the second set of one or more slots.

In some aspects, process 900 includes detect the first grant in the first set of one or more slots, wherein monitoring for the second grant in the second set of one or more slots, or refraining from monitoring for the second grant in the second set of one or more slots, comprises monitor for the second grant in the second set of one or more slots in accordance with detecting the first grant in the first set of one or more slots.

In some aspects, the indication indicates a pattern of the first set of one or more slots having the first priority level and the second set of one or more slots having the second priority level.

In some aspects, process 900 includes transmitting information indicating at least one of a preferred slot pattern of the first set of one or more slots and the second set of one or more slots or a length of a time window of the first set of one or more slots and the second set of one or more slots.

In some aspects, the preferred slot pattern indicates a preferred set of slots with a first priority level and a preferred set of slots with a second priority level.

In some aspects, the first set of one or more slots and the second set of one or more slots are included in the active time that includes multiple occurrences of the first set of one or more slots and multiple occurrences of the second set of one or more slots.

In some aspects, process 900 includes receiving a second indication, wherein the second indication includes a modification of at least one of: the slot pattern of the first set of one or more slots and the second set of one or more slots, or a length of a time window that includes the first set of one or more slots and the second set of one or more slots.

In some aspects, the first set of one or more slots occur earlier, in the active time, than the second set of one or more slots.

In some aspects, process 900 includes receiving a DRX configuration associated with the DRX cycle, wherein the DRX configuration indicates a connected-mode DRX (C-DRX) related timer parameter for the DRX cycle; and receiving an adjustment to the C-DRX related timer parameter, wherein monitoring for the second grant in the second set of one or more slots is in accordance with the adjustment to the C-DRX related timer parameter.

In some aspects, receiving the adjustment is via a physical downlink control channel downlink control information message or a medium access control control element.

In some aspects, the C-DRX related timer parameter is associated with at least one of a DRX inactivity timer a hybrid automatic repeat request (HARQ) round-trip timer for at least one of an uplink or a downlink, or a HARQ retransmission timer for at least one of an uplink or a downlink.

In some aspects, refraining from monitoring for the second grant in the second set of one or more slots comprises refraining from monitoring for the second grant in accordance with not detecting the first grant in the first set of one or more slots.

In some aspects, monitoring for the second grant in the second set of one or more slots comprises monitoring for the second grant in accordance with detecting the first grant in the first set of one or more slots.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node. Example process 1000 is an example where the network node (such as a network node 110) performs operations associated with slot prioritization for connected mode discontinuous reception.

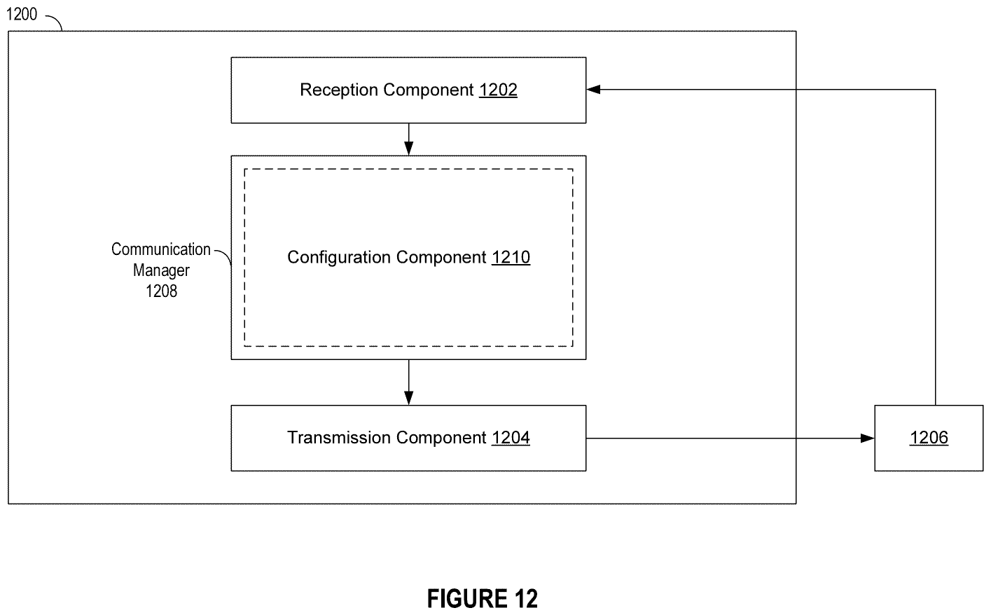

As shown in FIG. 10, in some aspects, process 1000 may include transmitting, to a UE, a DRX configuration indicating a DRX cycle (block 1010). For example, the network node (for example, using communication manager 1208 and/or transmission component 1204, depicted in FIG. 12) may transmit, to a UE, a DRX configuration indicating a DRX cycle, as described above.

As further shown in FIG. 10, in some aspects, process 1000 may include transmitting an indication of a slot pattern including a first set of one or more slots having a first priority level and a second set of one or more slots having a second priority level, wherein the first set of one or more slots and the second set of one or more slots are included in an active time of the DRX cycle (block 1020). For example, the network node (for example, using communication manager 1208 and/or transmission component 1204, depicted in FIG. 12) may transmit an indication of a slot pattern including of a first set of one or more slots having a first priority level and a second set of one or more slots having a second priority level, wherein the first set of one or more slots and the second set of one or more slots are included in an active time of the DRX cycle, as described above.

Process 1000 may include additional aspects, such as any single aspect or any combination of aspects described below and/or in connection with one or more other processes described elsewhere herein.

In some aspects, the first set of one or more slots is associated with a first priority level and the second set of one or more slots is associated with a second priority level according to the slot pattern.

In some aspects, the slot pattern is common to a plurality of UEs including the UE.

In some aspects, process 1000 includes buffering or delaying transmission for multiple UEs such that the transmission for the multiple UEs occurs in the first set of one or more slots.

In some aspects, process 1000 includes buffering or delaying transmission for multiple UEs such that the transmission for the multiple UEs occurs outside of the second set of one or more slots.

In some aspects, process 1000 includes entering a sleep state during the second set of one or more slots in association with no grant having been transmitted in the first set of one or more slots.

In some aspects, process 1000 includes receiving information indicating at least one of a preferred slot pattern of the first set of one or more slots and the second set of one or more slots or a length of a time window of the first set of one or more slots and the second set of one or more slots.

In some aspects, the first set of one or more slots and the second set of one or more slots are included in a time window that includes multiple occurrences of the first set of one or more slots and multiple occurrences of the second set of one or more slots, and wherein the time window is associated with the active time.

In some aspects, process 1000 includes transmitting a second indication via radio resource control signaling, medium access control signaling, or downlink control information, wherein the second indication includes a modification of at least one of a pattern of the first set of one or more slots and the second set of one or more slots, or a length of a time window that includes the first set of one or more slots and the second set of one or more slots.

In some aspects, process 1000 includes transmitting a plurality of grants to a plurality of UEs, including the UE, in the first set of one or more slots; and entering a sleep state in the second set of one or more slots.

In some aspects, process 1000 includes transmitting an adjustment to a connected-mode DRX (C-DRX) related timer parameter via a physical downlink control channel downlink control information message, a medium access control control element, or downlink control information.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication that supports slot prioritization for connected mode discontinuous reception in accordance with the present disclosure. The apparatus 1100 may be a UE (for example, a UE 120), or a UE may include the apparatus 1100. In some aspects, the apparatus 1100 includes a reception component 1102, a transmission component 1104, and a communication manager 1108, which may be in communication with one another (for example, via one or more buses). As shown, the apparatus 1100 may communicate with another apparatus 1106 (such as another UE 120, a network node 110, or another wireless communication device) using the reception component 1102 and the transmission component 1104. The communication manager 1108 may be included in, or implemented via, a processing system (for example, the processing system 140) of the UE.

In some aspects, the apparatus 1100 may be configured to and/or operable to perform one or more operations described herein in connection with FIGS. 3-8. Additionally or alternatively, the apparatus 1100 may be configured to and/or operable to perform one or more processes described herein, such as process 900 of FIG. 9, or a combination thereof.

The reception component 1102 may receive communications, such as reference signals, control information, and/or data communications, from the apparatus 1106. The reception component 1102 may provide received communications to one or more other components of the apparatus 1100, such as the communication manager 1108. In some aspects, the reception component 1102 may perform signal processing on the received communications, and may provide the processed signals to the one or more other components in a similar manner as described above in connection with FIG. 1. In some aspects, the reception component 1102 may include one or more components of the UE 120 described above in connection with FIG. 1, such as a radio, one or more RF chains, one or more transceivers, or one or more modems, each of which may in turn be coupled with one or more antennas of the UE 120.

The transmission component 1104 may transmit communications, such as reference signals, control information, and/or data communications, to the apparatus 1106. In some aspects, the communication manager 1108 may generate communications and may transmit the generated communications to the transmission component 1104 for transmission to the apparatus 1106. In some aspects, the transmission component 1104 may perform signal processing on the generated communications, and may transmit the processed signals to the apparatus 1106 in a similar manner as described above in connection with FIG. 1. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE 120. In some aspects, the transmission component 1104 may be co-located with the reception component 1102.

The reception component 1102 may receive an indication of a slot pattern including a first set of one or more slots having a first priority level and a second set of one or more slots having a second priority level. The reception component 1102 may monitor for a first grant in the first set of one or more slots in accordance with the slot pattern. The reception component 1102 or the transmission component 1104 may monitor for a second grant in the second set of one or more slots in accordance with the slot pattern, or refrain from monitoring for the second grant in the second set of one or more slots, in association with whether the grant is detected in the first set of one or more slots.

In some aspects, the communication manager 1108 includes a set of components, such as a monitoring component 1110. Alternatively, the set of components may be separate and distinct from the communication manager 1108. As used herein, the term “component” is intended to be broadly construed as hardware or a combination of hardware and at least one of software or firmware. In some aspects, one or more components of the set of components may include or may be implemented within a processing system (for example, the processing system 140 of the UE 120). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 1102 or the communication manager 1108 may receive an indication of a slot pattern including a first set of one or more slots having a first priority level and a second set of one or more slots having a second priority level. The reception component 1102 or the monitoring component 1110 may monitor for a first grant in the first set of one or more slots in accordance with the slot pattern. The reception component 1102, the transmission component 1104, or the communication manager 1108 may monitor for a second grant in the second set of one or more slots in accordance with the slot pattern, or refrain from monitoring for the second grant in the second set of one or more slots, in association with whether the first grant is detected in the first set of one or more slots.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication that supports slot priority for connected-mode discontinuous reception in accordance with the present disclosure. The apparatus 1200 may be a network node (for example, a network node 110), or a network node may include the apparatus 1200. In some aspects, the apparatus 1200 includes a reception component 1202, a transmission component 1204, and a communication manager 1208, which may be in communication with one another (for example, via one or more buses). As shown, the apparatus 1200 may communicate with another apparatus 1206 (such as a UE 120, a network node 110, or another wireless communication device) using the reception component 1202 and the transmission component 1204. The communication manager 1208 may be included in, or implemented via, a processing system (for example, the processing system 145) of the network node.

In some aspects, the apparatus 1200 may be configured to and/or operable to perform one or more operations described herein in connection with FIGS. 3-8. Additionally or alternatively, the apparatus 1200 may be configured to and/or operable to perform one or more processes described herein, such as process 1000 of FIG. 10, or a combination thereof.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a receive processor, a memory, or a combination thereof, of the network node. In some aspects, the reception component 1202 may include or be included in an interface for communication with another apparatus, such as a network node.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a transceiver, a memory, or a combination thereof, of the network node described in connection with FIG. 1. In some aspects, the transmission component 1204 may be co-located with the reception component 1202 in a transceiver. In some aspects, the transmission component 1204 may include or be included in an interface for communication with another apparatus, such as a network node.

The transmission component 1204 may transmit, to a UE, a DRX configuration indicating a DRX cycle. The transmission component 1204 may transmit an indication of a slot pattern including a first set of one or more slots and a second set of one or more slots, wherein the first set of one or more slots and the second set of one or more slots are included in an active time of the DRX cycle.

In some aspects, the communication manager 1208 includes a set of components, such as a configuration component 1210. Alternatively, the set of components may be separate and distinct from the communication manager 1208. As used herein, the term “component” is intended to be broadly construed as hardware or a combination of hardware and at least one of software or firmware. In some aspects, one or more components of the set of components may include or may be implemented within a processing system (for example, the processing system 145 of the network node 110). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 1204 or the configuration component 1210 may transmit, to a UE, a DRX configuration indicating a DRX cycle. The transmission component 1204 or the configuration component 1210 may transmit an indication of a slot pattern including a first set of one or more slots and a second set of one or more slots, wherein the first set of one or more slots and the second set of one or more slots are included in an active time of the DRX cycle.

The quantity and arrangement of components shown in FIG. 12 are provided as an example. In practice, there may be additional components, fewer components, different components, or differently arranged components than those shown in FIG. 1. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 1.

Implementation examples are described in the following numbered clauses:
Clause 1: A method of wireless communication at a user equipment (UE), comprising: receiving an indication of a slot pattern comprising a first set of one or more slots and a second set of one or more slots, wherein the first set of one or more slots and the second set of one or more slots are included in an active time of a discontinuous reception (DRX) cycle; monitoring for a grant in the first set of one or more slots in accordance with the slot pattern; and performing a communication in the second set of one or more slots in accordance with the slot pattern, or refraining from performing the communication in the second set of one or more slots, in association with whether the grant is detected in the first set of one or more slots.
Clause 2: The method of Clause 1, wherein the first set of one or more slots is associated with a first priority level and the second set of one or more slots is associated with a second priority level according to the slot pattern, wherein monitoring for the grant in the first set of one or more slots is associated with the first set of one or more slots being associated with the first priority level, and wherein performing the communication in the second set of one or more slots is associated with the second set of one or more slots being associated with the second priority level.
Clause 3: The method of Clause 2, further comprising transmitting, prior to receiving the indication, capability information indicating support for the slot pattern with the first priority level and the second priority level, wherein the indication is in accordance with the capability information.
Clause 4: The method of any of Clauses 1-3, wherein receiving the indication comprises receiving the indication via a radio resource control (RRC) message.
Clause 5: The method of Clause 4, wherein the slot pattern is common to a plurality of UEs including the UE.
Clause 6: The method of any of Clauses 1-5, wherein monitoring for the grant in the first set of one or more slots comprises failing to detect the grant in the first set of one or more slots, and wherein performing the communication in the second set of one or more slots, or refraining from performing the communication in the second set of one or more slots, comprises refraining from performing the communication in the second set of one or more slots in accordance with failing to detect the grant in the first set of one or more slots.
Clause 7: The method of Clause 6, further comprising entering a sleep state during the second set of one or more slots.
Clause 8: The method of any of Clauses 1-7, wherein monitoring for the grant in the first set of one or more slots comprises detecting the grant in the first set of one or more slots, and wherein performing the communication in the second set of one or more slots, or refraining from performing the communication in the second set of one or more slots, comprises performing the communication in the second set of one or more slots in accordance with detecting the grant in the first set of one or more slots.
Clause 9: The method of any of Clauses 1-8, wherein the indication indicates a pattern of the first set of one or more slots and the second set of one or more slots.
Clause 10: The method of any of Clauses 1-9, comprising transmitting information indicating at least one of a preferred slot pattern of the first set of one or more slots and the second set of one or more slots or a length of a time window of the first set of one or more slots and the second set of one or more slots.
Clause 11: The method of Clause 10, wherein the preferred slot pattern indicates a preferred set of slots with a first priority level and a preferred set of slots with a second priority level.
Clause 12: The method of Clause 10, wherein the information is associated with at least one of a traffic condition or a determination at the UE.
Clause 13: The method of Clause 12, wherein the determination is associated with an artificial intelligence or machine learning functionality.
Clause 14: The method of any of Clauses 1-13, wherein the first set of one or more slots and the second set of one or more slots are included in a time window that includes multiple occurrences of the first set of one or more slots and multiple occurrences of the second set of one or more slots.
Clause 15: The method of Clause 14, wherein the multiple occurrences of the first set of one or more slots are multiplexed in time with the multiple occurrences of the second set of one or more slots.
Clause 16: The method of any of Clauses 1-15, further comprising receiving a second indication, wherein the second indication includes a modification of at least one of: the slot pattern of the first set of one or more slots and the second set of one or more slots, or a length of a time window that includes the first set of one or more slots and the second set of one or more slots.
Clause 17: The method of Clause 16, wherein receiving the second indication comprises receiving the second indication via a physical downlink control channel downlink control information message or a medium access control control element.
Clause 18: The method of any of Clauses 1-17, wherein the first set of one or more slots occur earlier, in the active time, than the second set of one or more slots.
Clause 19: The method of any of Clauses 1-18, further comprising: receiving a DRX configuration associated with the DRX cycle, wherein the DRX configuration indicates a timer parameter for the DRX cycle; and receiving an adjustment to the timer parameter, wherein at least one of monitoring for the grant in the first set of one or more slots or monitoring for the communication in the second set of one or more slots is in accordance with the adjustment to the timer parameter.
Clause 20: The method of Clause 19, wherein receiving the adjustment comprises receiving the adjustment via a physical downlink control channel downlink control information message or a medium access control control element.
Clause 21: The method of Clause 19, further comprising transmitting, prior to receiving the adjustment, capability information indicating support for the adjustment, wherein the adjustment is in accordance with the capability information.
Clause 22: The method of Clause 19, wherein the adjustment indicates an incremental change to a length of a timer indicated by the timer parameter.
Clause 23: The method of Clause 19, wherein the adjustment indicates to reset a length of a timer indicated by the timer parameter to a value indicated by the DRX configuration.
Clause 24: The method of Clause 19, further comprising receiving a configuration that indicates at least one of: a feature associated with the adjustment is activated, or an increment associated with the adjustment.
Clause 25: The method of Clause 19, wherein the timer parameter is associated with at least one of: a DRX inactivity timer, a hybrid automatic repeat request (HARQ) round-trip timer for at least one of an uplink or a downlink, or a HARQ retransmission timer for at least one of an uplink or a downlink.
Clause 26: A method of wireless communication at a network node, comprising: transmitting, to a user equipment (UE), a discontinuous reception (DRX) configuration indicating a DRX cycle; and transmitting an indication a slot pattern comprising of a first set of one or more slots and a second set of one or more slots, wherein the first set of one or more slots and the second set of one or more slots are included in an active time of the DRX cycle.
Clause 27: The method of Clause 26, wherein the first set of one or more slots is associated with a first priority level and the second set of one or more slots is associated with a second priority level according to the slot pattern.
Clause 28: The method of Clause 27, further comprising receiving, prior to transmitting the indication, capability information indicating support for the slot pattern with the first priority level and the second priority level, wherein the indication is in accordance with the capability information.
Clause 29: The method of any of Clauses 26-28, wherein the slot pattern is common to a plurality of UEs including the UE.
Clause 30: The method of any of Clauses 26-29, further comprising entering a sleep state during the second set of one or more slots in association with no grant having been transmitted in the first set of one or more slots.
Clause 31: The method of any of Clauses 26-30, further comprising transmitting a grant in the first set of one or more slots; and transmitting a communication in the second set of one or more slots in association with transmitting the grant in the first set of one or more slots.
Clause 32: The method of any of Clauses 26-31, wherein the first set of one or more slots occurs earlier, in the active time, than the second set of one or more slots.
Clause 33: The method of any of Clauses 26-32, comprising receiving information indicating at least one of a preferred slot pattern of the first set of one or more slots and the second set of one or more slots or a length of a time window of the first set of one or more slots and the second set of one or more slots.
Clause 34: The method of Clause 33, wherein the preferred slot pattern indicates a preferred set of slots with a first priority level and a preferred set of slots with a second priority level.
Clause 35: The method of Clause 33, wherein the information is associated with at least one of a traffic condition or a determination at the UE.
Clause 36: The method of Clause 35, wherein the indication is associated with the information.
Clause 37: The method of any of Clauses 26-36, wherein the first set of one or more slots and the second set of one or more slots are included in a time window that includes multiple occurrences of the first set of one or more slots and multiple occurrences of the second set of one or more slots.
Clause 38: The method of Clause 37, wherein the multiple occurrences of the first set of one or more slots are multiplexed in time with the multiple occurrences of the second set of one or more slots.
Clause 39: The method of any of Clauses 26-38, further comprising transmitting a second indication, wherein the second indication includes a modification of at least one of: a pattern of the first set of one or more slots and the second set of one or more slots, or a length of a time window that includes the first set of one or more slots and the second set of one or more slots.
Clause 40: The method of any of Clauses 26-39, further comprising: transmitting a plurality of grants to a plurality of UEs, including the UE, in the first set of one or more slots.
Clause 41: The method of Clause 40, further comprising entering a sleep state in the second set of one or more slots.
Clause 42: The method of any of Clauses 26-41, wherein the DRX configuration indicates a timer parameter for the DRX cycle, and the method further comprises transmitting an adjustment to the timer parameter.
Clause 43: The method of Clause 42, wherein transmitting the adjustment comprises transmitting the adjustment via a physical downlink control channel downlink control information message or a medium access control control element.
Clause 44: The method of Clause 42, further comprising receiving, prior to transmitting the adjustment, capability information indicating support for the adjustment, wherein the adjustment is in accordance with the capability information.
Clause 45: The method of Clause 42, wherein the adjustment indicates an incremental change to a length of a timer indicated by the timer parameter.
Clause 46: The method of Clause 42, wherein the adjustment indicates to reset a length of a timer indicated by the timer parameter to a value indicated by the DRX configuration.
Clause 47: The method of Clause 42, further comprising transmitting a configuration that indicates at least one of: a feature associated with the adjustment is activated, or an increment associated with the adjustment.
Clause 48: The method of Clause 42, wherein the timer parameter is associated with at least one of: a DRX inactivity timer, a hybrid automatic repeat request (HARQ) round-trip timer for at least one of an uplink or a downlink, or a HARQ retransmission timer for at least one of an uplink or a downlink.
Clause 49: A method of wireless communication at a user equipment (UE), comprising: receive an indication of a slot pattern comprising a first set of one or more slots having a first priority level and a second set of one or more slots having a second priority level, wherein the first set of one or more slots and the second set of one or more slots are included in an active time of a discontinuous reception (DRX) cycle; and monitor for a second grant in the second set of one or more slots in accordance with the slot pattern, or refrain from monitoring for the second grant in the second set of one or more slots, in association with whether a first grant is detected in the first set of one or more slots.
Clause 50: The method of Clause 49, further comprising monitoring for the first grant in the first set of one or more slots in association with the first set of one or more slots having the first priority level, wherein monitoring for the second grant in the second set of one or more slots is associated with the second set of one or more slots having the second priority level.
Clause 51: The method of any of Clauses 49-50, further comprising transmitting, prior to receiving the indication, capability information indicating support for the slot pattern with the first priority level and the second priority level, wherein the indication is in accordance with the capability information.
Clause 52: The method of any of Clauses 49-51, wherein the slot pattern is common to a plurality of UEs including the UE.
Clause 53: The method of any of Clauses 49-52, further comprising entering a sleep state during refraining from monitoring the second grant in the second set of one or more slots.
Clause 54: The method of any of Clauses 49-53, further comprising detecting the first grant in the first set of one or more slots, wherein monitoring for the second grant in the second set of one or more slots, or refraining from monitoring for the second grant in the second set of one or more slots, comprises monitoring for the second grant in the second set of one or more slots in accordance with detecting the first grant in the first set of one or more slots.
Clause 55: The method of any of Clauses 49-54, wherein the indication indicates a pattern of the first set of one or more slots having the first priority level and the second set of one or more slots having the second priority level.
Clause 56: The method of any of Clauses 49-55, further comprising transmitting information indicating at least one of a preferred slot pattern of the first set of one or more slots and the second set of one or more slots or a length of a time window of the first set of one or more slots and the second set of one or more slots.
Clause 57: The method of Clause 56, wherein the preferred slot pattern indicates a preferred set of slots with the first priority level and a preferred set of slots with the second priority level.
Clause 58: The method of Clause 56, wherein the information is associated with at least one of a traffic condition or a determination at the UE.
Clause 59: The method of Clause 57, wherein the determination is associated with an artificial intelligence or machine learning functionality.
Clause 60: The method of any of Clauses 49-59, wherein the first set of one or more slots and the second set of one or more slots are included in the active time that includes multiple occurrences of the first set of one or more slots and multiple occurrences of the second set of one or more slots.
Clause 61: The method of Clause 60, wherein the multiple occurrences of the first set of one or more slots are multiplexed in time with the multiple occurrences of the second set of one or more slots.
Clause 62: The method of any of Clauses 49-61, further comprising receiving a second indication, wherein the second indication includes a modification of at least one of: the slot pattern of the first set of one or more slots and the second set of one or more slots, or a length of a time window that includes the first set of one or more slots and the second set of one or more slots.
Clause 63: The method of Clause 62, wherein receiving the second indication comprises receiving the second indication via a physical downlink control channel downlink control information message or a medium access control control element.
Clause 64: The method of any of Clauses 49-63, wherein the first set of one or more slots occur earlier, in the active time, than the second set of one or more slots.
Clause 65: The method of any of Clauses 49-64, further comprising: receiving a DRX configuration associated with the DRX cycle, wherein the DRX configuration indicates a connected-mode DRX (C-DRX) related timer parameter for the DRX cycle; and receiving an adjustment to the C-DRX related timer parameter, wherein monitoring for the communication in the second set of one or more slots is in accordance with the adjustment to the timer parameter.
Clause 66: The method of Clause 65, wherein receiving the adjustment comprises receiving the adjustment via a physical downlink control channel downlink control information message or a medium access control control element.
Clause 67: The method of Clause 65, further comprising transmitting, prior to receiving the adjustment, capability information indicating support for the adjustment, wherein the adjustment is in accordance with the capability information.
Clause 68: The method of Clause 65, wherein the adjustment indicates an incremental change to a length of a timer indicated by the timer parameter.
Clause 69: The method of Clause 65, wherein the adjustment indicates to reset a length of a timer indicated by the timer parameter to a value indicated by the DRX configuration.
Clause 70: The method of Clause 65, further comprising receiving a configuration that indicates at least one of: a feature associated with the adjustment is activated, or an increment associated with the adjustment.
Clause 71: The method of Clause 65, wherein the C-DRX related timer parameter is associated with at least one of: a DRX inactivity timer, a hybrid automatic repeat request (HARQ) round-trip timer for at least one of an uplink or a downlink, or a HARQ retransmission timer for at least one of an uplink or a downlink.
Clause 72: The method of Clause 65, wherein refraining from monitoring for the second grant in the second set of one or more slots comprises refraining from monitoring for the second grant in accordance with not detecting the first grant in the first set of one or more slots.
Clause 73: The method of Clause 65, wherein monitor for the second grant in the second set of one or more slots comprises monitoring for the second grant in accordance with detecting the first grant in the first set of one or more slots.
Clause 74: A method of wireless communication at a network node, comprising: transmitting, to a user equipment (UE), a discontinuous reception (DRX) configuration indicating a DRX cycle; and transmitting an indication a slot pattern comprising of a first set of one or more slots having a first priority level and a second set of one or more slots having a second priority level, wherein the first set of one or more slots and the second set of one or more slots are included in an active time of the DRX cycle.
Clause 75: The method of Clause 74, wherein the first set of one or more slots is associated with a first priority level and the second set of one or more slots is associated with a second priority level according to the slot pattern.
Clause 76: The method of any of Clauses 74-75, further comprising receiving, prior to transmitting the indication, capability information indicating support for the slot pattern with the first priority level and the second priority level, wherein the indication is in accordance with the capability information.
Clause 77: The method of any of Clauses 74-76, wherein the slot pattern is common to a plurality of UEs including the UE.
Clause 78: The method of any of Clauses 74-77, further comprising buffering or delaying transmission for multiple UEs such that the transmission for the multiple UEs occurs in the first set of one or more slots.
Clause 79: The method of any of Clauses 74-78, further comprising buffering or delaying transmission for multiple UEs such that the transmission for the multiple UEs occurs outside of the second set of one or more slots.
Clause 80: The method of any of Clauses 74-79, further comprising entering a sleep state during the second set of one or more slots in association with no grant having been transmitted in the first set of one or more slots.
Clause 81: The method of any of Clauses 74-80, further comprising transmitting a grant in the first set of one or more slots; and transmitting a communication in the second set of one or more slots in association with transmitting the grant in the first set of one or more slots.
Clause 82: The method of any of Clauses 74-81, wherein the first set of one or more slots occurs earlier, in the active time, than the second set of one or more slots.
Clause 83: The method of any of Clauses 74-82, comprising receiving information indicating at least one of a preferred slot pattern of the first set of one or more slots and the second set of one or more slots or a length of a time window of the first set of one or more slots and the second set of one or more slots.
Clause 84: The method of Clause 83, wherein the preferred slot pattern indicates a preferred set of slots with a first priority level and a preferred set of slots with a second priority level.
Clause 85: The method of Clause 83, wherein the information is associated with at least one of a traffic condition or a determination at the UE.
Clause 86: The method of Clause 85, wherein the indication is associated with the information.
Clause 87: The method of any of Clauses 74-86, wherein the first set of one or more slots and the second set of one or more slots are included in a time window that includes multiple occurrences of the first set of one or more slots and multiple occurrences of the second set of one or more slots and wherein the time window is associated with the active time.
Clause 88: The method of Clause 87, wherein the multiple occurrences of the first set of one or more slots are multiplexed in time with the multiple occurrences of the second set of one or more slots.
Clause 89: The method of any of Clauses 74-88, further comprising transmitting a second indication via radio resource control signaling, medium access control signaling, or downlink control information, wherein the second indication includes a modification of at least one of: a pattern of the first set of one or more slots and the second set of one or more slots, or a length of a time window that includes the first set of one or more slots and the second set of one or more slots.
Clause 90: The method of any of Clauses 74-89, wherein the DRX configuration indicates a C-DRX related timer parameter for the DRX cycle, and the method further comprises transmitting an adjustment to the timer parameter.
Clause 91: One or more apparatuses, comprising: one or more memories comprising executable instructions; and one or more processors configured to execute the executable instructions and cause the one or more apparatuses to perform a method in accordance with any one of clauses 1-90.
Clause 92: One or more apparatuses, comprising: one or more memories; and one or more processors, coupled to the one or more memories, configured to cause the one or more apparatuses to perform a method in accordance with any one of Clauses 1-90.
Clause 93: One or more apparatuses, comprising: one or more memories; and one or more processors, coupled to the one or more memories, configured to perform a method in accordance with any one of Clauses 1-90.
Clause 94: One or more apparatuses, comprising means for performing a method in accordance with any one of Clauses 1-90.
Clause 95: One or more non-transitory computer-readable media comprising executable instructions that, when executed by one or more processors of one or more apparatuses, cause the one or more apparatuses to perform a method in accordance with any one of Clauses 1-90.
Clause 96: One or more computer program products embodied on one or more computer-readable storage media comprising code for performing a method in accordance with any one of Clauses 1-90.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) comprising a processing system that includes processor circuitry and memory circuitry that stores code, the processing system configured to cause the UE to:
receive an indication of a slot pattern comprising a first set of one or more slots having a first priority level and a second set of one or more slots having a second priority level, wherein the first set of one or more slots and the second set of one or more slots are included in an active time of a discontinuous reception (DRX) cycle; and
monitor for a second grant in the second set of one or more slots in accordance with the slot pattern, or refrain from monitoring for the second grant in the second set of one or more slots, in association with whether a first grant is detected in the first set of one or more slots.

2. The UE of claim 1, wherein the processing system is configured to cause the UE to monitor for the first grant in the first set of one or more slots in association with the first set of one or more slots having the first priority level, and wherein monitoring for the second grant in the second set of one or more slots is associated with the second set of one or more slots having the second priority level.

3. The UE of claim 2, wherein the processing system is configured to cause the UE to transmit, prior to receiving the indication, capability information indicating support for the slot pattern with the first priority level and the second priority level, wherein the indication is in accordance with the capability information.

4. The UE of claim 1, wherein the slot pattern is common to a plurality of UEs including the UE.

5. The UE of claim 1, wherein the processing system is configured to cause the UE to enter a sleep state during refraining from monitoring the second grant in the second set of one or more slots.

6. The UE of claim 1, wherein the processing system is configured to cause the UE to detect the first grant in the first set of one or more slots, and wherein the processing system, to cause the UE to monitor for the second grant in the second set of one or more slots, or refrain from monitoring for the second grant in the second set of one or more slots, is configured to cause the UE to monitor for the second grant in the second set of one or more slots in accordance with detecting the first grant in the first set of one or more slots.

7. The UE of claim 1, wherein the indication indicates a pattern of the first set of one or more slots having the first priority level and the second set of one or more slots having the second priority level.

8. The UE of claim 1, wherein the processing system is configured to cause the UE to transmit information indicating at least one of a preferred slot pattern of the first set of one or more slots and the second set of one or more slots or a length of a time window of the first set of one or more slots and the second set of one or more slots.

9. The UE of claim 8, wherein the preferred slot pattern indicates a preferred set of slots with the first priority level and a preferred set of slots with the second priority level.

10. The UE of claim 1, wherein the first set of one or more slots and the second set of one or more slots are included in the active time and wherein the active time includes multiple occurrences of the first set of one or more slots and multiple occurrences of the second set of one or more slots.

11. The UE of claim 1, wherein the processing system is configured to cause the UE to receive a second indication, wherein the second indication includes a modification of at least one of:
the slot pattern of the first set of one or more slots and the second set of one or more slots, or
a length of a time window that includes the first set of one or more slots and the second set of one or more slots.

12. The UE of claim 1, wherein the first set of one or more slots occur earlier, in the active time, than the second set of one or more slots.

13. The UE of claim 1, wherein the processing system is configured to cause the UE to:
receive a DRX configuration associated with the DRX cycle, wherein the DRX configuration indicates a connected-mode DRX (C-DRX) related timer parameter for the DRX cycle; and
receive an adjustment to the C-DRX related timer parameter, wherein monitoring for the second grant in the second set of one or more slots is in accordance with the adjustment to the C-DRX related timer parameter.

14. The UE of claim 13, wherein the processing system, to cause the UE to receive the adjustment, is configured to cause the UE to receive the adjustment via a physical downlink control channel downlink control information message or a medium access control control element.

15. The UE of claim 13, wherein the C-DRX related timer parameter is associated with at least one of:
a DRX inactivity timer,
a hybrid automatic repeat request (HARQ) round-trip timer for at least one of an uplink or a downlink, or
a HARQ retransmission timer for at least one of an uplink or a downlink.

16. The UE of claim 1, wherein the processing system, to cause the UE to refrain from monitoring for the second grant in the second set of one or more slots, is configured to cause the UE to refrain from monitoring for the second grant in accordance with not detecting the first grant in the first set of one or more slots.

17. The UE of claim 1, wherein the processing system, to cause the UE to monitor for the second grant in the second set of one or more slots, is configured to cause the UE to monitor for the second grant in accordance with detecting the first grant in the first set of one or more slots.

18. A network node comprising a processing system that includes processor circuitry and memory circuitry that stores code, the processing system configured to cause the network node to:
transmit, to a user equipment (UE), a discontinuous reception (DRX) configuration indicating a DRX cycle; and
transmit an indication of a slot pattern comprising a first set of one or more slots having a first priority level and a second set of one or more slots having a second priority level, wherein the first set of one or more slots and the second set of one or more slots are included in an active time of the DRX cycle.

19. The network node of claim 18, wherein the first set of one or more slots is associated with the first priority level and the second set of one or more slots is associated with the second priority level according to the slot pattern.

20. The network node of claim 18, wherein the slot pattern is common to a plurality of UEs including the UE.

21. The network node of claim 18, wherein the processing system is configured to cause the network node to buffer or delay transmission for multiple UEs such that the transmission for the multiple UEs occurs in the first set of one or more slots.

22. The network node of claim 18, wherein the processing system is configured to cause the network node to buffer or delay transmission for multiple UEs such that the transmission for the multiple UEs occurs outside of the second set of one or more slots.

23. The network node of claim 18, wherein the processing system is configured to cause the network node to enter a sleep state during the second set of one or more slots in association with no grant having been transmitted in the first set of one or more slots.

24. The network node of claim 18, wherein the processing system is configured to cause the network node to receive information indicating at least one of a preferred slot pattern of the first set of one or more slots and the second set of one or more slots or a length of a time window of the first set of one or more slots and the second set of one or more slots.

25. The network node of claim 18, wherein the first set of one or more slots and the second set of one or more slots are included in a time window that includes multiple occurrences of the first set of one or more slots and multiple occurrences of the second set of one or more slots, and wherein the time window is associated with the active time.

26. The network node of claim 18, wherein the processing system is configured to cause the network node to transmit a second indication via radio resource control signaling, medium access control signaling, or downlink control information, wherein the second indication includes a modification of at least one of:
a pattern of the first set of one or more slots and the second set of one or more slots, or
a length of a time window that includes the first set of one or more slots and the second set of one or more slots.

27. The network node of claim 18, wherein the processing system is configured to cause the network node to transmit a plurality of grants to a plurality of UEs, including the UE, in the first set of one or more slots; and
enter a sleep state in the second set of one or more slots.

28. The network node of claim 18, wherein the processing system is configured to cause the network node to transmit an adjustment to a connected-mode DRX (C-DRX) related timer parameter via a physical downlink control channel downlink control information message, a medium access control control element, or downlink control information.

29. A method of wireless communication at a user equipment (UE), comprising:
receiving an indication of a slot pattern comprising a first set of one or more slots having a first priority level and a second set of one or more slots having a second priority level, wherein the first set of one or more slots and the second set of one or more slots are included in an active time of a discontinuous reception (DRX) cycle; and
monitoring for a second grant in the second set of one or more slots in accordance with the slot pattern, or refraining from monitoring for the second grant in the second set of one or more slots, in association with whether a first grant is detected in the first set of one or more slots.

30. A method of wireless communication at a network node, comprising:
transmitting, to a user equipment (UE), a discontinuous reception (DRX) configuration indicating a DRX cycle; and
transmitting an indication of a slot pattern comprising a first set of one or more slots having a first priority level and a second set of one or more slots having a second priority level, wherein the first set of one or more slots and the second set of one or more slots are included in an active time of the DRX cycle.
